(19) United States
(12) Patent Application Publication
(10) Pub. No.: US 2024/0061561 A1
(43) Pub. Date: Feb. 22, 2024

(54) VISUALLY-DEEMPHASIZED EFFECT FOR COMPUTING DEVICES

(71) Applicant: MICROSOFT TECHNOLOGY LICENSING, LLC, Redmond, WA (US)

(72) Inventors: Travis Jay POPKAVE, Seattle, WA (US); Jonathan Marshall CAIN, Seattle, WA (US); Savoy Dean SCHULER, Bellevue, WA (US)

(21) Appl. No.: 17/892,901

(22) Filed: Aug. 22, 2022

(51) Int. Cl. G06F 3/04842; G06F 3/04812; G06F 3/01

(52) U.S. Cl. CPC G06F 3/04842; G06F 3/04812; G06F 3/013; G06F 2203/04804

(57) ABSTRACT

Computerized systems and methods are provided for automatically causing a visually-deemphasized effect to be applied to a portion of the graphical user interface (GUI) that excludes a GUI element of a computer application determined to be in a user-attention state. A user-attention state may correspond to a computer state associated with a GUI element that indicates that the GUI element on a screen has or should have a user's attention. GUI elements presented using a visually-deemphasized effect are presented in a visually altered manner, such as blurred, grayscale, or otherwise visually modified. Embodiments include monitoring and classifying user data and user activity associated with a GUI element. Based on the classification, the GUI element is determined to be in the user-attention state to cause the visually-deemphasized effect to be applied to a portion of the GUI that excludes the first GUI element.

### BACKGROUND

Personal computing devices, such as laptops, computers, and smartphones, now carry and display a great variety of information and are used in a variety of settings. As computational efficiency has improved, personal computing devices have been able to run an increased number of computer applications, thereby delivering diverse functionality to individuals and enterprises. This diverse functionality may facilitate completion of complex tasks, on which people may spend significant time. For more complicated tasks, people may simultaneously run a variety of computer applications and folders. Each computer application may correspond to a graphical user interface (GUI) element that may contain additional GUI elements, such as icons or other branded visualizations or controls useful in visually distinguishing the computer applications from one another.

When a variety of computer applications, each occupying space on a display surface, are open, people may become distracted and lose focus. As a result, people's efficiency may suffer, network bandwidth may be consumed by people engaging in peripheral tasks, and the efficiency of an enterprise may suffer. Although a target computer application can be maximized to consume the entire screen (and thereby hide GUI elements of other computer applications) or less relevant computer applications may be minimized, maximizing the target computer application or minimizing the less relevant computer application(s) requires user intervention, which causes further user and enterprise inefficiencies and waste of network bandwidth and computer processing resources.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments described in the present disclosure are directed toward technologies for improving electronic operations of computer applications and user computing experiences on user computing devices (sometimes referred to herein as mobile devices, desktops, laptops, VR headsets, or user devices). In particular, this disclosure provides technologies to programmatically cause a visually-deemphasized effect to be applied to a portion of the graphical user interface (GUI) that excludes a GUI element of a computer application determined to be in a user-attention state. GUI elements presented using a visually-deemphasized effect are presented in a visually altered manner, such as blurred, grayscale, or otherwise visually deficient as discussed herein. A user-attention state may correspond to a computer state associated with a GUI element, which indicates that the GUI element on a screen has or should have a user's attention. Determining that a GUI element is in the user-attention state may be based on user activity data. The GUI element in the user-attention state may be referred to herein as “a hyper-focus element,” while GUI elements not in the user-attention state may be referred to herein as “non-hyper-focus elements.”

Embodiments described in the present disclosure are directed toward technologies for determining that a GUI element is a hyper-focus element and altering the display of non-hyper-focus elements. In more detail, a hyper-focus element may correspond to any GUI element, such as a computer application window, icon, button, or other GUI feature that is in the user-attention state. The hyper-focus element may be displayed using a hyper-focus effect that includes displaying the hyper-focus elements without alterations or with visually enhanced effects relative to surrounding content. On the other hand, the non-hyper-focus element(s) may correspond to the computer application window(s), icon(s), button(s), or other GUI features not in the user-attention state and that are presented using the visually-deemphasized effect. For example, when presented using the visually-deemphasized effect, the non-hyper-focus elements may be blurred, grayscaled, blackened out, or with an altered saturation, hue, or brightness, or otherwise presented in a manner that makes the hyper-focus elements relatively emphasized.

Embodiments described in the present disclosure include determining user data and user activity associated with a GUI element, such as a visual aspect of a computer application. User data may include information about a user and user-activity data may include the user's interactions with a GUI element. A GUI element may be presented using the hyper-focus effect or using the visually-deemphasized effect based on the user data. Such technologies improve the user experience associated with any of a number of computer applications and platforms by, among other benefits, automatically reducing the distractions presented to the user. Moreover, in addition to improving user efficiency, work produced by an enterprise may increase and network bandwidth may be preserved, as less computational resources are allocated to presenting all content on the screen in a similar, fully emphasized manner. Further, presenting GUI elements using certain visually-deemphasized effects, such as monotone, grayscaled, blackened out, or otherwise altered saturation, hue, or brightness, reduces the computer processing and other computer resources that otherwise would be needed to render those GUI elements in a fully emphasized manner. Further still, presenting GUI elements using certain visually-deemphasized effects can save battery power, since the visually-deemphasized effect may require using less power than conventional display methods that present all of the GUI elements in a fully emphasized manner.

### BRIEF DESCRIPTION OF THE DRAWINGS

Aspects of the disclosure are described in detail below with reference to the attached drawing figures, wherein:

FIG. 1 is a block diagram of an example computing environment suitable for use in implementing some embodiments of this disclosure;

FIG. 2 is a block diagram illustrating an example system in which some embodiments of this disclosure are employed;

FIGS. 3A-3F illustratively depict example schematic screenshots from a personal computing device showing aspects of an example graphical user interface, in accordance with some embodiments of the present disclosure;

FIGS. 4 and 5 depict flow diagrams of methods for programmatically causing a visually-deemphasized effect to be applied to a portion of a display surface of a graphical user interface presented by a personal computing device, in accordance with an embodiment of the present disclosure;

FIG. 6 is a block diagram of a computing device for which embodiments of this disclosure are employed; and

FIG. 7 is a block diagram of a computing environment in which embodiments of the present disclosure may be employed.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone computer application, a service or hosted service (stand-alone or in combination with another hosted service), or a plug-in to another product, to name a few.

Aspects of the present disclosure relate to technology for improving electronic computing technology and enhanced computing services for a user, based on user data associated with application data corresponding to a computer application. In particular, this disclosure provides technologies to programmatically cause a visually-deemphasized effect to be applied to a portion of the graphical user interface (GUI) that excludes a GUI element of a computer application determined to be in a user-attention state. GUI elements presented using a “visually-deemphasized effect,” as discussed herein, are presented in a visually altered manner, such as blurred, grayscale, or otherwise visually deficient, as discussed herein. As discussed herein, a “user-attention state” may correspond to a computer state, associated with a GUI element on a screen that indicates that the GUI element has or should have a user's attention. Determining that a GUI element is in the user-attention state may be based on user activity data. For example, user activity data may indicate that a user is drafting a document, such that a GUI element associated with a word processing computer application may be determined to be in the user-attention state. To facilitate discussion, the GUI element in the user-attention state may be referred to herein as “a hyper-focus element,” while GUI elements not in the user-attention state may be referred to herein as “non-hyper-focus elements.” Accordingly, a “hyper-focus element,” may correspond to any GUI element, such as a visual aspect of a computer application, a window, a taskbar, a background, an icon, a button, or other GUI feature that is determined to be in the user-attention state and displayed using the hyper-focus effect.

Embodiments described in the present disclosure are directed toward technologies for determining that a GUI element is a hyper-focus element (that is, determined to be in the user-attention state), and in response, alter display of non-hyper-focus elements. As used herein, a “computer application,” “software application,” or “application” may refer to a computer program designed to carry out a specific task other than one relating to operation of the computer, for example, by end-users. The computer application may be presented to the end user as a window or other visual aspect associated with the computer application. Example computer applications include word processing computer applications (sometimes referred to as word processors), media players, accounting software, web browsers, and so forth. A person of ordinary skill in the art would understand that multiple windows corresponding to one computer application may be simultaneously running, such that each of the windows may be a GUI element of the computer application or a feature of a window may be a GUI element of the computer application. Moreover, it should be understood that by employing the embodiments herein, one window of the computer application may be presented using a hyper-focused effect, while another window of the same computer application may be presented using the visually-deemphasized effect.

As used herein, a “hyper-focus effect” may correspond to a visual presentation style in which the hyper-focus element is presented in a manner that is emphasized relative to surrounding GUI elements. Although the embodiments described herein generally discuss a hyper-focus element presented using the hyper-focus effect as (1) remaining unaltered, it should be understood that a hyper-focus element presented using the hyper-focus effect may (2) be presented with any computer-generated image-enhancing alterations relative to surrounding GUI elements. A GUI element presented using the hyper-focus effect may (1) remain unmodified and/or presented without alteration or (2) be presented with any computer-generated image-enhancing alteration. For example, this may include presenting the hyper-focus element using a sharper image resolution, increased saturation level, a border effect applied to the GUI element, such as a highlighting color or brightness, or a shadow, and so forth.

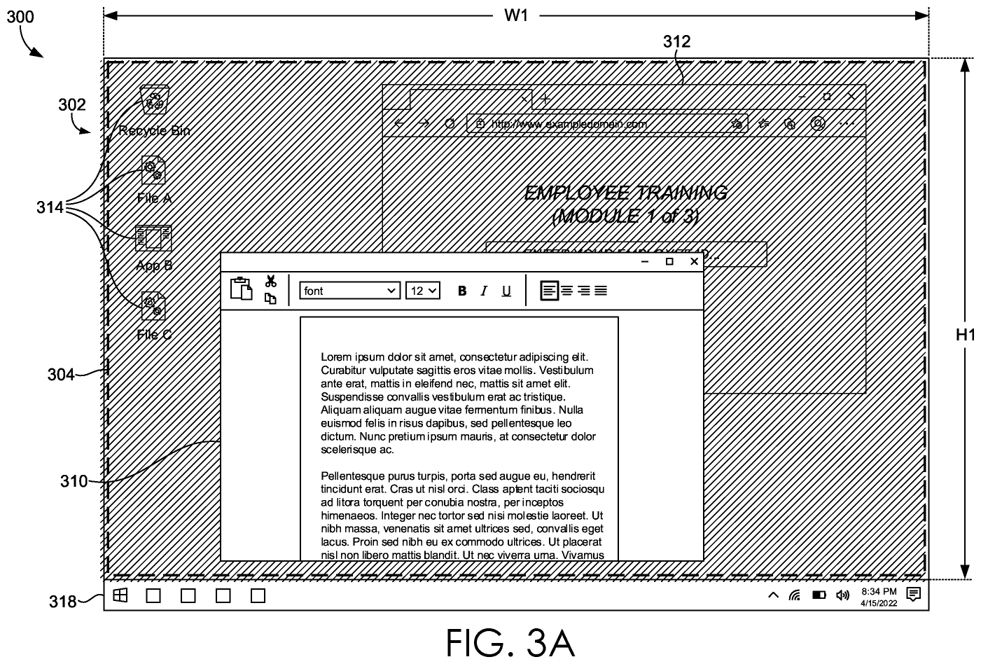

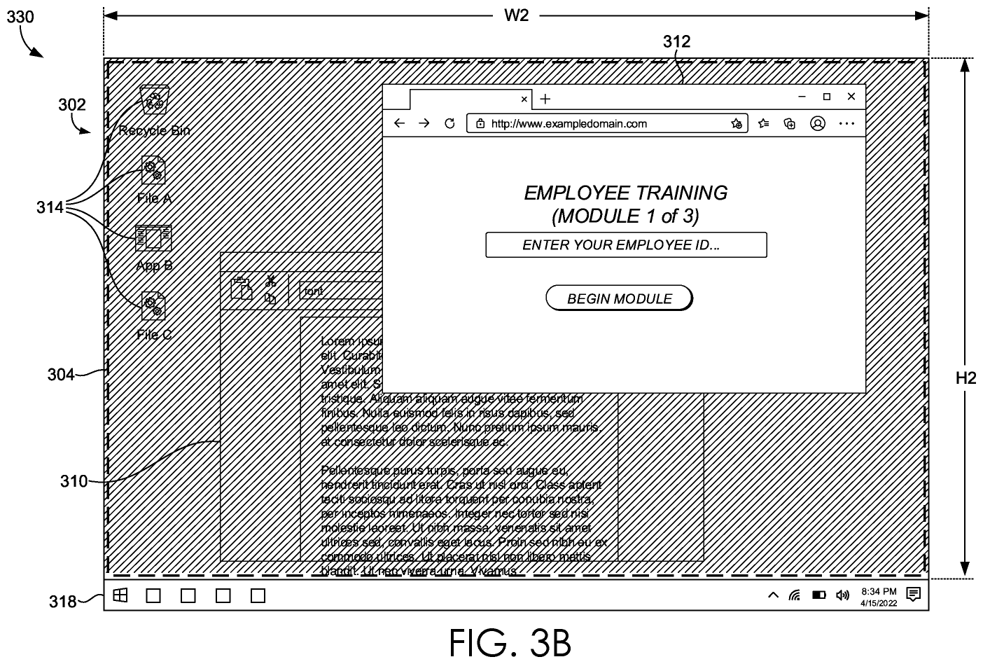

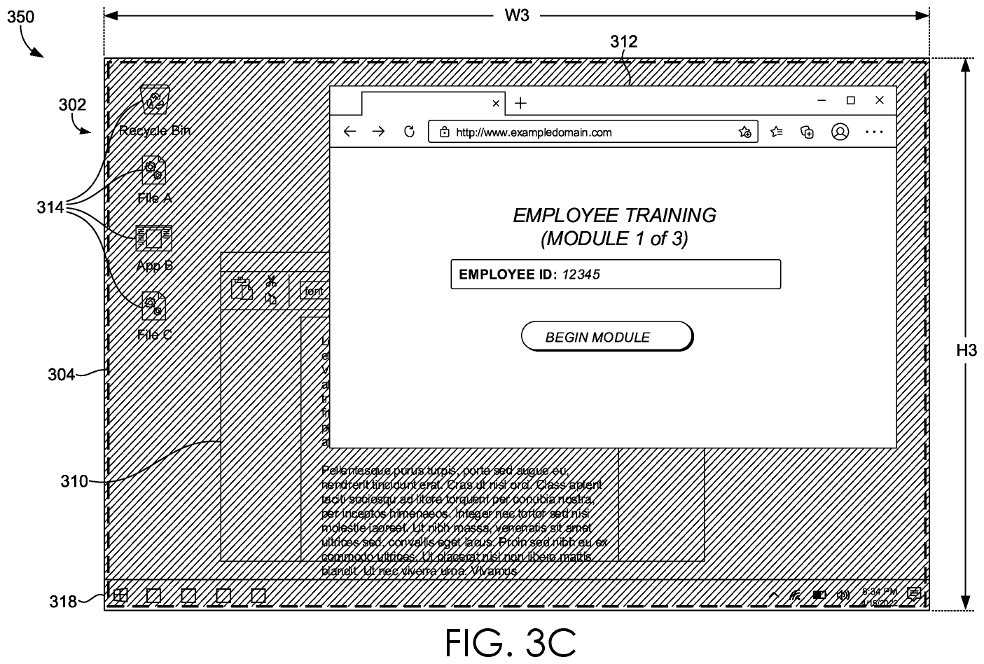

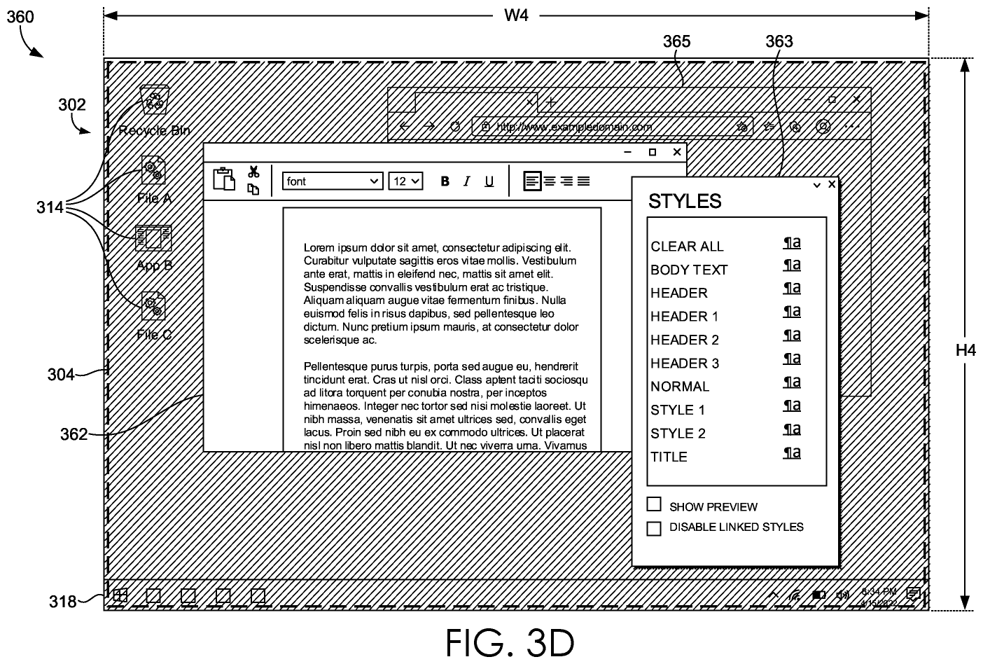

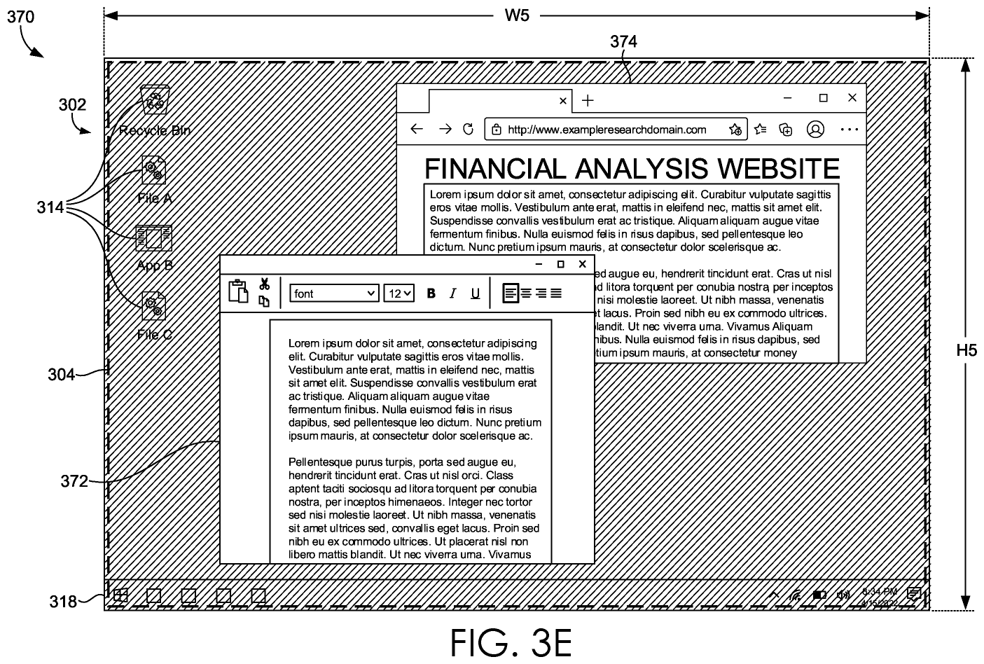

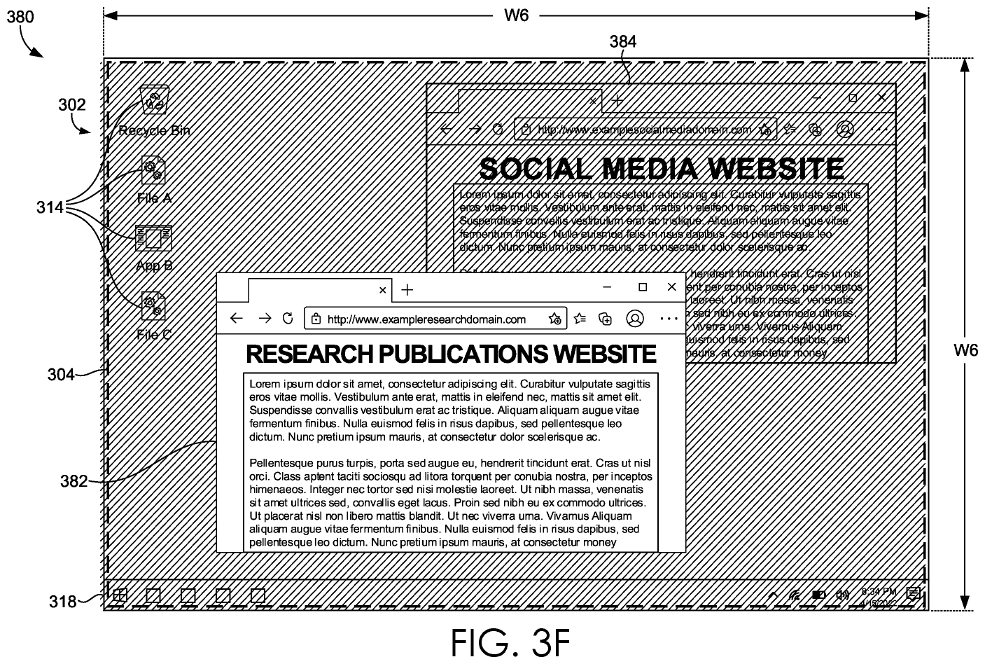

To better differentiate the hyper-focus elements from the non-hyper-focus elements (i.e., the GUI elements that have not been identified as in a user-attention state), embodiments described in the present disclosure include causing a visually-deemphasized effect to be applied to non-hyper-focused elements. As used herein, the “non-hyper-focused element” corresponds to a GUI element that is not determined to be in a user-attention state. As used herein, the “visually-deemphasized effect” may refer to a visual presentation style in which the non-hyper-focused elements are presented with a visual alteration to visually distinguish the non-hyper-focus elements from the hyper-focused elements. By way of non-limiting example, the visually-deemphasized effect includes a grayscale, black-out, a monotone, a blur, an altered saturation, an altered contrast, an altered hue, an altered brightness, or any other visual alteration applied to the non-hyper-focus elements. In some embodiments, the visually-deemphasizing effect is applied by a computing device as an operating system-level pixel adjuster. An example of GUI elements provided using the visually-deemphasized effect and the hyper-focus effect are illustrated in FIGS. 3A through 3F.

Embodiments described in the present disclosure include determining user data and user-activity data associated with a GUI element, such as a computer application (for example, a software application) or associated window. The user data may include information about the user (for example, calendar information or patterns of application usage across other applications), and the user-activity data may include the user's interaction with a particular GUI element. As used herein, in some embodiments, “user data” may broadly refer to data associated with a user, including the user-activity data. The user data may include an indication of a productivity of the user while using a variety of computer applications, a pattern of user interactions with the computer applications, preferences from an administrator regarding permissible access to the computer application and/or user preferences. In some embodiments, the user-activity data associated with the GUI element may be based on application data. Application data may refer to any data associated with the computer application, including the type of computer application (for example, a productivity computer application, a web browser computer application, or a multimedia computer application), version of the computer application, average time users spend on the computer application, battery consumed by running the computer application, and so forth.

To help illustrate and by way of non-limiting example, suppose a user opens a first computer application corresponding to a productivity application, such as a word processing computer application, and a second computer application corresponding to a web browser. The computing device may present, on a graphical user interface of a display, a first window corresponding to the first computer application and a second window corresponding to the second computer application. Further, suppose that the computing device accesses user-activity data indicative of the user's interactions with the first and second computer application, as well as other user data, such as user data from a scheduling calendar, task list, email or chat communications. Based on the user-activity data and/or the user data, the computing device may determine that the user has a particular outstanding task to perform ahead of a meeting time or deadline, such as finalizing a draft of a particular document that is a project plan. For example, user data from the scheduling calendar, a task list, or email may be used to determine the outstanding task and/or deadline. Based on the user data and/or the user-activity data, the computing device may classify the user-activity data to determine a productivity score for the first and second computer applications. Based on the respective productivity scores, the computing device may determine that the first computer application (which is the word processing computer application, in this example) has a higher productivity score and therefore is likely to be used for the project plan task.

Accordingly, the computing device may determine that the first computer application is (or should be) in the user-attention state. As a result, the computing device may cause, for example, the entire GUI, except the portion of the GUI corresponding to those GUI elements in the user-attention state (for example, GUI elements associated with the first computer application), to transition to being presented using the visually-deemphasized effect. Thus, in this example, GUI elements associated with the second computer application that is a web browser would transition to being presented using the visually-deemphasized effect.

The transition to being presented using the visually-deemphasized effect may occur in a minimally obstructive manner, such as over a period of time, such as 5 seconds, 30 seconds, 1 minute, 15 minutes, 30 minutes, and the like. The timing for applying the visually-deemphasized effect may be based on the user data and/or the user-activity data. In this manner, the first computer application, which is determined to be in the user-attention state, remains unaltered (using the hyper-focus effect) to reduce distraction and enable the user to better focus on the first computer application, and thus better focus on completing the task of finalizing the draft project plan.

### Overview of Technical Problems, Technical Solutions, and Technological Improvements

The coalescence of telecommunications and personal computing technologies in the modern era has enabled, for the first time in human history, information on demand and a ubiquity of personal computing resources (including mobile personal computing devices and cloud-computing coupled with communication networks). As a result, it is increasingly common for users to rely on one or more mobile computing devices throughout the day for handling various tasks. It is also now possible to provide a never-ending quantity of information to the user regardless of whether the information will facilitate handling of a task or merely serve another purpose, such as a distraction.

As described previously, in response to a variety of running computer applications, each occupying space on a display surface, such as a computer screen, users may become distracted and lose focus. As a result, users' efficiency may suffer, network bandwidth may be consumed by people engaging with certain computer applications (for example, to stream videos, listen to music, browse social media web sites, or download content), and the efficiency of an enterprise may suffer. Users may try to manually configure the GUI elements presented on the display surface in a manner that mitigates these problems, for instance by maximizing a window of a target computer application so that it occupies the entire screen (and thereby hiding GUI elements of other computer applications) and/or by minimizing windows of less relevant computer applications. But this requires user intervention, which causes further user and enterprise inefficiencies and waste of network bandwidth and computer processing resources. Conventional computing and display technologies do not include functionality for effectively addressing these problems. In particular, the conventional technology does not include functionality for applying a hyper-focus effect for viewing GUI elements that (1) reduces user inputs, for example, by not requiring a user to maximizing or minimize computer applications; (2) conserves computer processing resources and battery by suspending a view, for example, using a visually-deemphasized effect) of GUI elements not in use or determine to not be in a user-attention state; and (3) provides flexibility for customization—the implementation of which may be difficult to achieve in practice.

Accordingly, automated computing technology for programmatically determining, surfacing, and/or utilizing user-activity data associated with data computer applications, as provided herein, can be beneficial for enabling improved computer applications and an improved user computing experience. Further, embodiments of this disclosure address a need that arises from a very large scale of operations created by software-based services that cannot be managed by humans. The actions/operations described herein address results of a system that is a direct consequence of software used as a service offered in conjunction with users engaging with services hosted across a variety of platforms and devices. Further still, embodiments of this disclosure enable an improved user experience across a number of computer devices, computer applications, and platforms. Further still, embodiments described herein enable certain GUI elements (for example, windows of a computer application) to be presented using a visually-deemphasized effect which may conserve computer processing resources and battery, provide an enhanced display of content on a GUI, and improve user productivity—all without requiring distracting user inputs or use of computing and network resources for a user to manually perform operations to produce this outcome. In this way, some embodiments, as described herein, reduce computational resources associated with otherwise presenting less relevant content (for example, GUI elements) with the same display properties (for example, resolution, saturation, and so forth) used to present relevant content (for example, GUI elements).

### Additional Description of the Embodiments

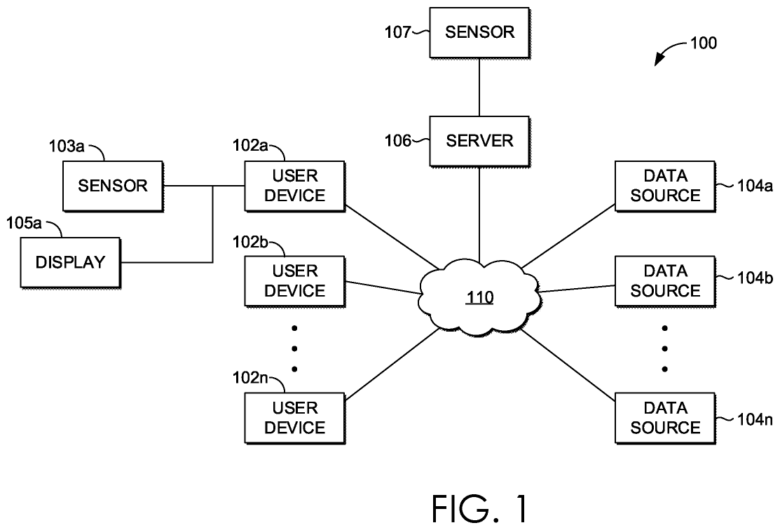

Turning now to FIG. 1, a block diagram is provided showing an example operating environment 100 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

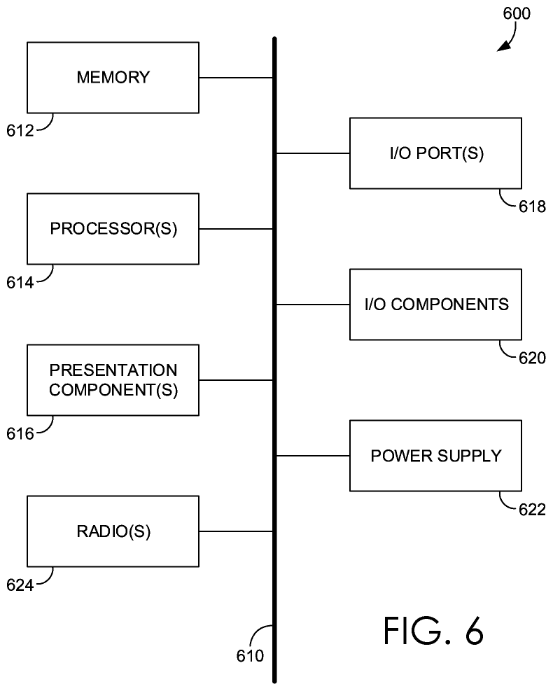

Among other components not shown, example operating environment 100 includes a number of user computing devices, such as: user devices 102a and 102b through 102n; a number of data sources, such as data sources 104a and 104b through 104n; display 105a; server 106; sensors 103a and 107; and network 110. It should be understood that environment 100 shown in FIG. 1 is an example of one suitable operating environment. Each of the components shown in FIG. 1 may be implemented via any type of computing device, such as computing device 600 described in connection to FIG. 6, for example. These components may communicate with each other via network 110, which may include, without limitation, one or more local area networks (LANs) and/or wide area networks (WANs). In example implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a smart speaker, a tablet computer, a smart watch, a virtual reality (VR) or augmented reality (AR) device or headset, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, any other suitable computer device, or any combination of these delineated devices. The display 105a may be integrated into the user devices 102a and 102b through 102n, for example, to facilitate presenting content, such as the GUI illustrated in FIGS. 3A through 3F. In one embodiment, the display 105a is a touchscreen display.

Sensors 103a and 107 may include a function, routine, component, or combination thereof for sensing, detecting, or otherwise obtaining information from a data source 104a, such as user data or user-activity data associated a computer application. A sensor 103a or 107 may be embodied as hardware, software, or both. For example, a sensor 103a may include a camera (such as a webcam or camera of a computing device) that tracks a user's vision gaze, posture, head position, and the like; a microphone that detects user utterances; a battery sensor that tracks battery consumption based on computer application usage; and the like. In some embodiments, the sensors 103a and 107 may be external to a server 106 or user device 102a. For example, a sensor 103a and 107 may correspond to a wearable sensor that determines information indicative of a user's bio-parameters (such as vitals, heart rate, blood pressure, oxygen levels, body mass index, and so forth) or current state, which may be used to determine the user's state of attention or focus. In one embodiment, the data from sensors 103a and/or 107 comprises (or may be stored in) one or more of the data sources 104a and 104b through 104n.

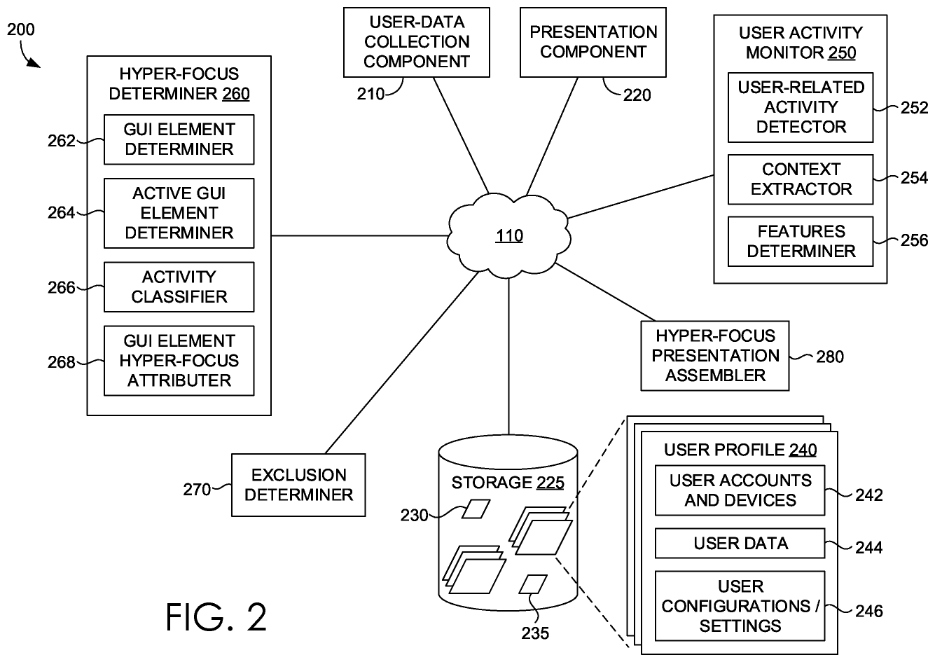

Data sources 104a and 104b through 104n may comprise data sources and/or data systems, which are configured to make data available to any of the various constituents of operating environment 100 or system 200 described in connection to FIG. 2. For instance, in one embodiment, one or more data sources 104a through 104n provide (or make available for accessing), to user-data collection component 210 of FIG. 2, user data (for example, associated with application data corresponding to a computer application), which may include user-activity data. Data sources 104a and 104b through 104n may be discrete from user devices 102a and 102b through 102n and server 106 or may be incorporated and/or integrated into at least one of those components. In one embodiment, one or more of data sources 104a through 104n comprise one or more sensors, such as sensors 103a and 107, which may be integrated into or associated with one or more of the user device(s) 102a, 102b through 102n, or server 106. Examples of sensed data made available by data sources 104a through 104n are described further in connection to user-data collection component 210 of FIG. 2.

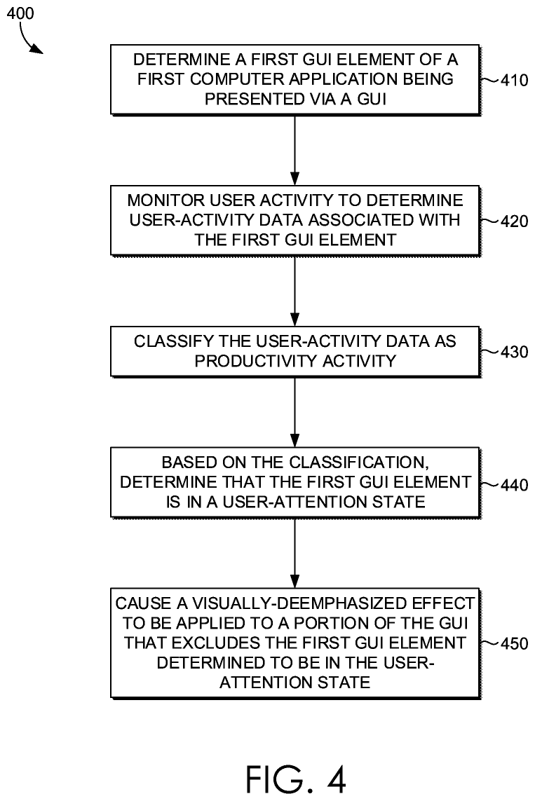

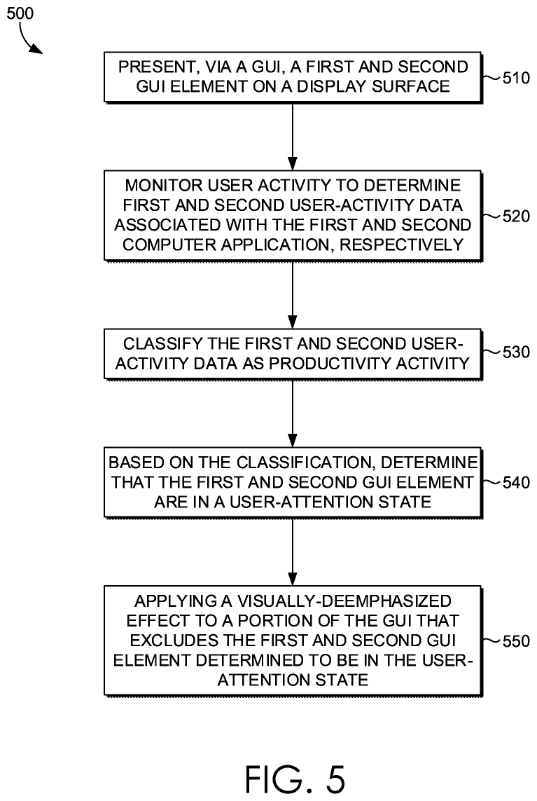

Operating environment 100 can be utilized to implement one or more of the components of system 200, described in FIG. 2, including components for collecting user data, which may comprise user-activity data associated with a computer application; monitoring user activity to determine user-activity data or user data features; and accessing user preferences, and/or application data, such as a type of computer application, a version of the computer application, average time the computer application is open, battery consumed by running the computer application, and so forth, to facilitate determining a hyper-focus element in the user-attention state or to otherwise provide an improved user experience. Operating environment 100 can also be utilized for implementing aspects of methods 400 and 500 in FIGS. 4 and 5, respectively.

Referring now to FIG. 2, with continuing reference to FIG. 1, a block diagram is provided showing aspects of an example computing system architecture suitable for implementing an embodiment of this disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200, including user-data collection component 210, presentation component 220, user activity monitor 250, hyper-focus determiner 260, exclusion determiner 270, hyper-focus presentation assembler 280, and storage 225. User activity monitor 250 (including its subcomponents 252, 254, and 256), exclusion determiner 270, hyper-focus determiner 260 (including its subcomponents 262, 264, 266, and 268), hyper-focus presentation assembler 280, user-data collection component 210, and presentation component 220, may be embodied as a set of compiled computer instructions or functions, program modules, computer software services, or an arrangement of processes carried out on one or more computer systems, such as computing device 600, described in connection to FIG. 6, for example.

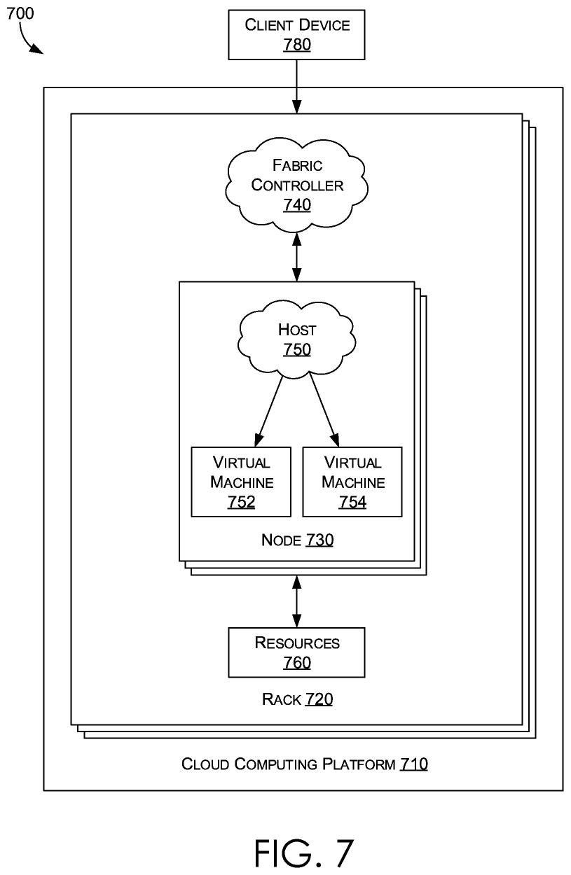

In one embodiment, the functions performed by components of system 200 are associated with one or more computer applications, services, or routines, such as a productivity computer application, a web browser computer application, a multimedia computer application, a taskbar, a folder navigator, and so forth. The functions may operate to determine a hyper-focus element (for example, a GUI element in a user-attention state) or apply a visually-deemphasized effect to at least a portion of the display area, such the entire display area, except the hyper-focus element, or otherwise to provide an enhanced computing experience for a user. In particular, such computer applications, services, or routines may operate on one or more user devices (such as user device 102a) or servers (such as server 106). Moreover, in some embodiments, these components of system 200 may be distributed across a network, including one or more servers (such as server 106) and/or client devices (such as user device 102a) in the cloud, such as described in connection with FIG. 7, or may reside on a user device, such as user device 102a. Moreover, these components, functions performed by these components, or services carried out by these components may be implemented at appropriate abstraction layer(s) such as the operating system layer, application layer, hardware layer, or other abstraction layer of the computing system(s). Alternatively, or in addition, the functionality of these components and/or the embodiments described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), of the like. Additionally, although functionality is described herein with regard to specific components shown in example system 200, it is contemplated that in some embodiments functionality of these components is shared or distributed across other components.

Continuing with FIG. 2, user-data collection component 210 is generally configured to access or receive (and in some cases also identify) user data, which may include data associated with a particular user, user-activity data associated with a computer application, application data associated with a computer application, or any suitable data from one or more data sources, such as data sources 104a and 104b through 104n of FIG. 1. In some embodiments, user-data collection component 210 may be employed to facilitate the accumulation of user data for user activity monitor 250 or its subcomponents, hyper-focus determiner 260 or its subcomponents, exclusion determiner 270, or hyper-focus presentation assembler 280. The data may be received (or accessed), and optionally accumulated, reformatted, and/or combined, by user-data collection component 210 and stored in one or more data stores such as storage 225, where it may be available to other components of system 200. For example, the user data may be stored in or associated with a user profile 240, as described herein, such as in user data 244 of user profile 240. In some embodiments, any personally identifying data (i.e., user data that specifically identifies particular users) is either not uploaded or otherwise provided from the one or more data sources, is not permanently stored, is de-identified, and/or is not made available to other components of system 200. In addition or alternatively, in some embodiments, a user may opt into or out of services provided by the technologies described herein and/or select which user data and/or which sources of user data are to be captured and utilized by these technologies.

User data, generally, may comprise any information that is related to a person, such as a user of a user device. User data may include the person's interactions with a GUI element, such as a computer application, and may be received from a variety of sources and may be available in a variety of formats. By way of example and without limitation, user data may comprise: contact information (for example, email, instant message, phone, and may also specify a person's communication preferences); location information (for example, a person's current location or location of a particular office where they work); presence; communications information (for example, past email, meetings, chat sessions, communication patterns or frequency, or information about communications between users); application data (for example, information about particular application documents, which may include metadata, calendar application data, schedule application data, online meeting application data, communications application data such as information about project teams the user is a member or, or other types of application data); user activity data, which may comprise user-related activity data or activity relevant to a user interaction with certain GUI elements (for example, GUI elements of a computer application); file access (for example, a file created, modified, or shared); social media or online activity, such as a post to a social-media platform or website, subscription information, browsing information regarding topics of interest to a user, or other user-related activity that may be determined via a user device; task-related information (for example, an outstanding task assigned to the user for completion); an administrator's preferences for the user (for example, security preferences, permissible computer applications, a role of the user, and so forth); and/or information about the user (for example, background, education, interests, hobbies, or work groups the user is a part of). Additional examples of user data are described herein.

In some embodiments, user data received via user-data collection component 210 may be obtained from a data source (such as data source 104a in FIG. 1, which may be a social networking site, a professional networking site, a corporate network, an organization's intranet or file share, or other data source containing user or user-activity data) or determined via one or more sensors (such as sensors 103a and 107 of FIG. 1), which may be on or associated with one or more user devices (such as user device 102a), servers (such as server 106), and/or other computing devices. As previously discussed, a sensor may include a function, routine, component, or combination thereof for sensing, detecting, or otherwise obtaining information such as user data from a data source 104a, and may be embodied as hardware, software, or both. By way of example and not limitation, user data may include data that is sensed, detected, or determined from one or more sensors (referred to herein as sensor data), such as location information of mobile device(s), properties or characteristics of the user device(s), user-activity information (for example: app usage); online activity; searches; voice data such as automatic speech recognition; activity logs; communications data, including calls, texts, chats, messages, and emails; document comments; website posts; other user data associated with communication events, including user history, session logs, application data, contacts data, calendar and schedule data, notification data, social-network data, ecommerce activity, user-account(s) data (which may include data from user preferences or settings associated with a personalization-related computer application, a personal assistant computer application or service, an online service or cloud-based account such as Microsoft 365, an entertainment or streaming media account, a purchasing club or services); global positioning system (GPS) data; other user device data (which may include device settings, profiles, network-related information, payment or credit card usage data, or purchase history data); other sensor data that may be sensed or otherwise detected by a sensor (or other detector) component(s), including data derived from a sensor component associated with the user (including location, motion, orientation, position, user-access, user-activity, network-access, user-device charging, or other data that is capable of being provided by one or more sensor component); data derived based on other data (for example, location data that can be derived from Wi-Fi, cellular network, or IP address data), and nearly any other source of data that may be sensed, detected, or determined as described herein.

User data, particularly in the form of context data or contextual information regarding a particular user, can be received by user-data collection component 210 from one or more sensors and/or computing devices associated with the user. In some embodiments, user-data collection component 210, user activity monitor 250 or its subcomponents, hyper-focus determiner 260 or its subcomponents, exclusion determiner 270, or other components of system 200 may determine interpretive data from received user data. Interpretive data corresponds to data utilized by the components or subcomponents of system 200 that comprises an interpretation from processing raw data, such as productivity information interpreted from raw user-activity information, or topic information interpreted from an email. Interpretive data can be used to provide context to user data, which can support determinations or inferences carried out by components of system 200. Interpretive data may correspond to user data associated with a computer application. Moreover, it is contemplated that some embodiments of the disclosure utilize user data alone or in combination with interpretive data for carrying out the objectives of the subcomponents described herein. It is also contemplated that some user data may be processed by the sensors or other subcomponents of user-data collection component 210 not shown, such as for interpretability by user-data collection component 210. However, embodiments described herein do not limit the user data to processed data and may include raw data or a combination thereof, as described above.

In some respects, user data may be provided in user-data streams or signals. A “user signal” can be a feed or stream of user data from a corresponding data source. For example, a user signal could be from a smartphone, a home-sensor device, a GPS device (for example, for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, as it becomes available, or as needed. In some embodiments, the user data, associated with application data corresponding to a computer application and which may be received by user-data collection component 210, is stored in storage 225, such as in user data 244.

User activity monitor 250 is generally responsible for monitoring user activity for information that may be used for determining user-activity data, which can include user data associated with a particular user's interactions with a GUI element. In some embodiments, user-activity data associated with a particular user determined via user activity monitor 250 comprises contextual information, such as context data, as further described herein. In some embodiments, the user data and/or user-activity data determined by user activity monitor 250 may be utilized by other components of system 200. For example the user-activity data may be used to infer an intent of the particular user, to determine that an application (or a GUI element of an application) is in a user-attention state or is not in a state of user attention, or otherwise to provide an enhanced computing experience for the user. In particular, embodiments of user activity monitor 250 may determine user data associated with a particular user, which may include user-activity data and/or context data, and may provide the determined user data as structured data, such as a set of data features, so that it may be used by other components of system 200. For instance, as further described herein, the user data may be used by hyper-focus determiner 260 to determine a set of GUI elements for presentation to the user, such that the GUI elements are relevant to the user's context, which may be indicated by the user data. Accordingly, in some embodiments, user data determined by user activity monitor 250 or its subcomponents may be used to determine a hyper-focus element. The user data determined by user activity monitor 250 or its subcomponents may also be stored in a user profile associated with a user, such as in user data 244 of user profile 240, where it may be accessible to other components of system 200.

In some embodiments, user activity monitor 250 may determine current or near-real-time user activity information and may also determine historical user activity information, which may be determined based on gathering observations of user activity over time, accessing user logs of past activity (such as user interactions with GUI elements, for example). Accordingly, user activity monitor 250 can determine current and historic user activity information that may be used by user activity monitor 250 or other components of system 200 to determine, for example: that a particular user currently completes work using a particular computer application, such as a productivity computer application; a pattern of computer usage or activity; or that certain files have been accessed, such as files that may be part of a project or other work-related task.

The user data determined by user activity monitor 250 (or its subcomponents) may include user-activity data from one or multiple user devices associated with a user and/or from cloud-based services associated with a user (such as email, calendars, social media, or similar information sources), and may further include contextual information associated with the user activity or user data. For example, information about user activity (with respect to a GUI element) on a particular device or cloud-based service may be used to determine a context associated with the user, which may be used for determining a hyper-focus element (i.e., GUI element in a user-attention state). In an embodiment, user activity monitor 250 comprises one or more computer applications or services that analyze information detected via one or more user devices used by a user and/or cloud-based services associated with the user to determine activity information and/or contextual information. Information about user devices associated with a user may be determined from the user data made available via user-data collection component 210, and may be provided to user activity monitor 250 or other components of system 200. More specifically, in some implementations of user activity monitor 250, a user device may be identified by detecting and analyzing characteristics of the user device, such as device hardware, software (such as operating system [OS]), network-related characteristics, user accounts accessed via the device, and similar characteristics. For example, information about a user device may be determined by using functionality of many operating systems to provide information about the hardware, OS version, network connection information, installed computer application, or the like.

Some embodiments of user activity monitor 250 or its subcomponents may determine a device name or identification (device ID) for each device associated with a user. This information about the identified user devices associated with a user may be stored in a user profile associated with the user, such as in user accounts and devices 242 of user profile 240. In an embodiment, a user device may be polled, interrogated, or otherwise analyzed to determine information about the device. This information may be used for determining a label or identification of the device (for example, a device ID) so that user interaction with the device may be recognized from user data by user activity monitor 250. In some embodiments, users may declare or register a device, such as by logging into an account via the device, installing a computer application on the device, connecting to an online service that interrogates the device, or otherwise providing information about the device to a computer application or service. In some embodiments, devices that sign into an account associated with the user, such as a Microsoft® account (MSA), email account, social network, or the like, are identified and determined to be associated with the user.

As shown in example system 200, user activity monitor 250 comprises a user-related activity detector 252, context extractor 254, and features determiner 256. In some embodiments, user activity monitor 250, one or more of its subcomponents, or other components of system 200 may determine interpretive data based on received user data, such as described previously. It is contemplated that embodiments of user activity monitor 250, its subcomponents, and other components of system 200 may use the user data and/or interpretive data for carrying out the objectives of the subcomponents described herein. Additionally, although several examples of how user activity monitor 250 and its subcomponents may identify user-activity data are described herein, many variations of user activity identification and user activity monitoring are possible in various embodiments of the disclosure.

User-related activity detector 252, in general, is responsible for determining (or identifying) that a user action or user-activity event has occurred. Embodiments of user-related activity detector 252 may be used for determining current user activity or historical user actions. Some embodiments of user-related activity detector 252 may monitor user data for activity-related features or variables corresponding to various user activity such as indications of user interactions with a computer application at certain periods during the day, information about the user's managers or superiors, information about meetings attended, computer applications (launched, accessed, or running), files accessed or shared, websites navigated to, media played, or similar user activities. Additionally, some embodiments of user-related activity detector 252 may extract, from the user data, information about user-related activity, which may include current user activity, historical user activity, and/or related information such as context. Alternatively, or in addition, in some embodiments, context extractor 254 determines and extracts context. Similarly, in some embodiments, features determiner 256 extracts information about a user, such as user-activity features, based on an identification of the activity determined by user-related activity detector 252. Examples of extracted user-activity data may include user location, app usage, online activity, searches, communications such as call or message information, usage duration, application data (for example, emails, meeting invites, messages, posts, user status, notifications, or the like), or nearly any other data related to user interactions with the user device or user activity via a user device. For example, a user's location may be determined using GPS, indoor positioning (IPS), or similar communication functionalities of a user device associated with a user.

Data determined from user-related activity detector 252 may be provided to other subcomponents of user activity monitor 250 or other components of system 200, or may be stored in a user profile associated with the user, such as in user data 244 of user profile 240. In some embodiments, user-related activity detector 252 or user activity monitor 250 (or its other subcomponents) performs conflation on detected user data. For example, overlapping information may be merged and duplicated, or redundant information may be eliminated.

In some embodiments, the user activity-related features may be interpreted to determine that particular user activity has occurred. For example, in some embodiments, user-related activity detector 252 employs user-activity event logic 230, which may include rules, conditions, associations, classification models, or other criteria to identify user activity. For example, in one embodiment, user activity event logic 230 may include comparing user activity criteria with the user data in order to determine that an activity event has occurred. Similarly, the user activity event logic 230 may specify types of detected user-device interaction(s) that are associated with an activity event, such as navigating to a website, composing an email, or launching an app. In some embodiments, a series or sequence of user device interactions may be mapped to an activity event, such that the activity event may be detected upon determining that the user data indicates that the series or sequence of user interactions has been carried out by the user.

In some embodiments, user activity detector 252 runs on or in association with each user device for a user. User activity detector 252 may include functionality that polls or analyzes aspects of the operating system to determine user activity related features (for example, installed or running computer applications or file accesses and modifications), network communications, and/or other user actions detectable via the user device including sequences of actions.

Context extractor 254 is generally responsible for determining a context associated with user activity or user data. As further described herein, a context (or context logic) may be used to determine a hyper-focus element, to assemble or format presentation of the hyper-focus element (using the hyper-focus effect) and the non-hyper-focus element (using the visually-deemphasized effect), or for consumption by a computer application. By way of example, a context may comprise information about a user's current activity, such as application usage while at work, or communication or interaction with other user(s). For instance, a context can indicate types of user activity, such as a user working, browsing the web during a lunch break, or viewing a message. Alternatively, or in addition, a user may explicitly provide a context, such as initiating a focus mode, in which computer applications and computer features (such as notifications and alerts) may be suppressed until the focus mode is disabled. A context may include information about a computer application, such as a productivity computer application that the user is interacting with or accessing information about, as in where a user hovers their mouse over the productivity computer application.

Some embodiments of context extractor 254 determine context related to a user action or activity event, user activity with respect to a GUI element, or data related to the activity (for example, the identity of a sender of a correspondence intended for the user). The context related to the user action or activity event may include whether the user is supposed to be performing work-related tasks based on historical data indicative of the user actions, a level of productivity of the user based on the user actions input to a GUI element associated with a computer application, and a role of a user interacting with the GUI element. Context extractor 252 may also determine location- or venue-related information about a user's device, which may include information about whether the user typically performs work-related tasks at the location. By way of example and not limitation, this may include context features such as: behavior data; contextual information about the location; duration of a user activity; other information about the activity such as entities associated with the activity (for example, venues, people, and objects); information detected by sensor(s) on user devices associated with the user that is concurrent or substantially concurrent to the detected user activity; or any other data related to the user activity that is detectable and that may be used for determining a context of the user-related activity.

In some embodiments, context extractor 254 comprises one or more computer applications or services that parse or analyze information detected via one or more user devices used by the user and/or cloud-based services associated with the user to identify, extract, or otherwise determine a user-related or user-device-related context. Alternatively, or in addition, some embodiments of context extractor 254 may monitor user data, such as that received by user-data collection component 210 or determined by user-related activity determiner 252, for information that may be used for determining a user context. In some embodiments, this information may comprise features (sometimes referred to herein as “variables”) or other information regarding specific user-activity and related contextual information. Some embodiments of context extractor 254 may determine, from the monitored user data, a user context associated with a particular user, the user's interactions within a computer application, or a user device. In some embodiments, a user context determined by context extractor 254 may be provided to other components of system 200 or stored in a user profile associated with a user, such as in user data 244 of user profile 240, where it may be accessed by other components of system 200.

Features determiner 256 is generally responsible for determining or extracting a set of one or more data features (or variables) characterizing the user and/or for determining structured user data associated with a user. User features may be determined from information about user data or user-activity data received from user-data collection component 210, which may include context data determined by user activity monitor 250. In some embodiments, features determiner 256 receives information from one or more of these other components of system 200 and processes the received information to determine a set of one or more features associated with a user. For example, user data processed by features determiner 256 may comprise unstructured, semi-structured, or structured data about a user (or other users). In some embodiments, this received user data may be converted into a structured data schema or record, a feature vector, a set of data feature-value pairs, or other data record that is usable for determining a hyper-focus element. The user features or structured user data determined by features determiner 256 may be provided to other components of system 200 or stored in a user profile associated with a user, such as in user data 244 of user profile 240, where it may be accessed by other components of system 200.

Examples of user features determined or extracted by features determiner 256 may include, without limitation: data from information sources associated with the user, such as an organizational chart or employment data (for example, who a user reports to, works with, manages [or who reports to a user]; a user's role; information about project team(s), which can include project-team members, or similar information); social media or social collaboration information sources (for example, the user's LinkedIn® connections or GitHub® contributions or collaborations); location-related features; venue-related information associated with the location or other location-related information; other users present at a venue or location; time-related features; current-user-related features, which may include information about the current or recent user of the user-device; user device-related features, such as device type (for example, desktop, tablet, mobile phone, fitness tracker, heart rate monitor, or other types of devices), hardware properties or profiles, OS or firmware properties, device IDs or model numbers, network-related information, position/motion/orientation-related information about the user device, network usage information, app usage on the device, user account(s) accessed or otherwise used (such as device account(s), OS level account(s), or online/cloud-service related account(s) activity, such as Microsoft® MSA account, online storage account(s), email, calendar, meetings, or social networking accounts); content-related features, such as types of GUI elements or computer application, presentations, or attendees; online activity (for example, searches, browsed websites, purchases, social networking activity, communications sent or received including social media posts); or any other features that may be detected or sensed and used for determining the hyper-focus GUI element for the user.

Some embodiments of features determiner 256, or more generally user activity monitor 250, can determine interpretive or semantic data from the user data, which may be used to determine user data features or other structured user data. For example, while a user-activity feature may indicate a computer application accessed by the user, a semantic analysis may determine information about the computer application, such as that the computer application is a productivity computer application, web browser computer application, or a multimedia computer application; or may determine other data associated with detected user activity or user data. Thus, semantic analysis may determine additional user-activity related features or user data that is semantically related to other data and which may be used for further characterizing the user or for determining a context.

In particular, a semantic analysis may be performed on at least a portion of user data to characterize aspects of the user data and user-activity data. For example, in some embodiments, user-activity features may be classified or categorized (such as by type, priority, time frame, level of productivity, work-related, home-related, themes, related entities, GUI element [such as whether the GUI element is a window, icon, button, selectable control, taskbar, or other visual aspect of a display background or computer application] and/or relation of the user to the GUI element [for example, the user created the GUI element, the user is required to access the GUI element to complete work-related tasks, or the like], or other categories), or related features may be identified for use in determining a similarity or relational proximity to other user-activity events. In some embodiments, a semantic analysis may utilize a semantic knowledge representation, such as a relational knowledge graph. A semantic analysis may also utilize semantic analysis logic, including rules, conditions, or associations to determine semantic information related to a user activity. For example, a user-activity event comprising an email sent to someone who works with the user may be characterized as a work-related activity, which may be used to infer that the user is performing a work-related task within a productivity computer application. A semantic analysis may also be used to further determine or characterize a context, such as determining that user-activity data associated with a particular GUI element is more likely than another GUI element to correspond to productivity activity that corresponds to a GUI element in a user-attention state. For example, a semantic analysis may include determining a first and second productivity scores for first and second user-activity data associated with first and second GUI elements, respectively. Based on a comparison of the first and second productivity scores, if the first productivity score is higher than the second productivity score, the second GUI element may be determined to be in the user-attention state. Alternatively, if the second productivity score is higher than the first productivity score, the first GUI element may be determined to be in the user-attention state. Alternatively, if the first productivity score and the second productivity score are the same or within a degree of similarity, the first and second GUI element may be determined to be in the user-attention state.

Continuing with FIG. 2, exclusion determiner 270 is generally responsible for determining an exclusion, namely, a GUI element that is excluded from being a GUI element in a user-attention state; and an inclusion, namely, a GUI element that may be a GUI element in the user-attention state. Accordingly, the exclusion determiner 270 may tag certain GUI elements so that presenting the tagged GUI element using the hyper-focus effect or using the visually-deemphasized effect is prohibited based on the tag. In this manner, a GUI element tagged as excluded as a hyper-focus element are prohibited from being displayed using the hyper-focus effect, while a GUI element tagged as excluded as a non-hyper-focus element cannot be presented using the visually-deemphasized effect. The exclusion determined by exclusion determiner 270 may be a permanent or temporary exclusion or inclusion, such as a GUI element may be excluded from being a hyper-focus element or non-hyper-focus element for a limited duration of time, depending on the type of computer application or other GUI element properties.

As non-limiting examples, a particular exclusion to the user-attention state determined by exclusion determiner 270 may comprise: a social media GUI element, a gambling GUI element, a phishing GUI element, a malware element, a gaming GUI element, or any other GUI element which may be excluded by an administrator or enterprise. As additional non-limiting examples, a particular inclusion using the visually-deemphasized effect includes a productivity computer application (for example, word processing application or Teams by Microsoft®), a message from enterprise personnel (such as the chief executive office), an advertisement, or any other suitable GUI element for which presentation using the visually-deemphasized effect is prohibited.

In some embodiments, an indication of the exclusion or inclusion is determined by exclusion determiner 270 based on user data and/or user-activity data, which may be received from user activity monitor 250 (or one of its subcomponents) from user data stored in a user profile, such as user data 244 in user profile 240, or from user-data collection component 210. In some instances, an indication of the exclusion or inclusion may be preset by an enterprise administrator or the user. For instance, an administrator may notice that the user-activity data indicates that the user is streaming movies at work. To prevent the user from streaming movies, the administrator may add a media computer application to the inclusions that may be in a user-attention state, such that media computer application (on which the user has been streaming videos) cannot be determined to be a GUI element in a user-attention state. In some embodiments, exclusion logic (stored in storage 225) may comprise a set of rules (which may include static or predefined rules or may be set based on settings or preferences in a user profile 240 associated with the user), Boolean logic, decision trees (for example, random forest, gradient boosted trees, or similar decision algorithms), conditions or other logic, a deterministic or probabilistic classifier, fuzzy logic, neural network, finite state machine, support vector machine, logistic regression, clustering, machine learning techniques, similar statistical classification processes, or combinations of these, to facilitate determining the exclusion or inclusion. Data associated with an exclusion or inclusion determined by exclusion determiner 270 may be stored in a user profile, such as user profile 240 in storage 225, and may be made accessible to the other components of system 200, such as hyper-focus determiner 260 and hyper-focus presentation assembler 280.

Continuing with FIG. 2, hyper-focus determiner 260 is generally responsible for determining at least one hyper-focus element. As set forth above, the hyper-focus element may correspond to any GUI element, such as a window, a taskbar, a background, an icon, a button, or other visual aspect of a computer application or computer background that is determined to be in the user-attention state and therefore displayed using the hyper-focus effect. Embodiments of hyper-focus determiner 260 may generate a hyper-focus element that is not prohibited by exclusion determiner 270. Thus, information about a GUI element, used to determine whether the GUI element is a hyper-focus element, may be received when it is not an exclusion or inclusion determined by the exclusion determiner 270. Data associated with the hyper-focus element determined by hyper-focus determiner 260 (or its subcomponents) may be stored in storage 225 (for example, as part of the user profile 240), where it may be used by other components or subcomponents of system 200. Alternatively, or in addition, data associated with the hyper-focus element determined by hyper-focus determiner 260 may be provided to a user, such as a user who is interacting a GUI presenting a plurality of GUI elements. In some embodiments, hyper-focus elements determined by hyper-focus determiner 260 (or its subcomponents) are presented using the hyper-focus effect (for example, by the hyper-focus presentation assembler 280 and/or the presentation component 220).

Embodiments of hyper-focus determiner 260 may determine hyper-focus elements based on: data associated with a GUI element, such as a computer application; data associated with a particular user, such as user-activity data indicative of a user's interactions with the particular GUI element; or a combination thereof. Hyper-focus determiner 260 may process user-activity data and/or data about the GUI element, both of which may be received from or determined from the user data determined by user activity monitor 250, user-data collection component 210, or from one or more user profiles 240, for example. As user data associated with a particular user may be utilized to determine that user's context or indicate that user's intent, as described previously, hyper-focus determiner 260 may determine a GUI element that is in the user-attention state (for example, a hyper-focus element) based on the user data, the user-activity data associated with the GUI element, or the user's context or intent.

Some embodiments of hyper-focus determiner 260 utilize hyper-focus data determination logic 235 to determine GUI elements associated with particular user data (for example, user-activity data) for presentation to a user. In particular, hyper-focus data determination logic 235 may comprise computer instructions including rules, conditions, associations, classification models, or other criteria for, among other operations, determining a hyper-focus element, determining relevance of a GUI element to a particular user, scoring or ranking GUI elements for relevance (for example, based on a productivity score), or contextualizing information about a GUI element for a user. Hyper-focus data determination logic 235 may take different forms, depending on the particular GUI element being determined, contextualized, or processed for relevance, and/or based on user data such as data indicating a context. For example, hyper-focus data determination logic 235 may comprise a set of rules, such as Boolean logic, various decision trees (for example, random forest, gradient boosted trees, or similar decision algorithms), conditions or other logic, fuzzy logic, neural network, finite state machine, support vector machine, machine-learning techniques, or combinations of these to determine (or facilitate determining) a hyper-focus GUI element that is in the user-attention state, according to embodiments described herein.

In some embodiments, the user data (for example, user-activity data) determined by hyper-focus determiner 260 (which may be determined using hyper-focus data determination logic 235) is based on explicit or inferred information about the GUI elements accessible on the GUI (for example, computer applications or windows that have been launched) and information about the user. For example, hyper-focus data determination logic 235 may include logic specifying instructions for detecting explicit information about a GUI element, or similarly for inferring user data based on particular user interactions, such as particular data features or patterns of user data features. Without limitation, examples of explicit information about a GUI element can comprise a name of the GUI element (for example, computer application name), whether the GUI element is being used, whether the GUI element is or has recently been used, whether the GUI element is being looked at by the user, and so forth. Examples of inferred data associated with a GUI element might comprise whether the GUI element is associated with a productivity computer application, whether the GUI element is not associated with the exclusion determiner 270, count of files accessed using the GUI element, and the like. For example, hyper-focus data determination logic 235 may include logic for determining information about GUI elements accessed by the user, such that hyper-focus determiner 260 may infer that, based on the GUI element being used to produce or accomplish a work task, a particular GUI element is in the user-attention state and should be presented to the user using the hyper-focus effect, which may indicate that the GUI element is helpful for accomplishing work-related tasks.

Some embodiments of hyper-focus data determination logic 235 comprise a plurality of logic for determining various types or categories of hyper-focus data (as determined by subcomponents 262, 264, 266, and 268), and may further include corresponding logic for determining the relevance to a user. Alternatively, in embodiments without hyper-focus data determination logic 235, hyper-focus determiner 260 may determine one or more categories of GUI elements associated with user-activity data for presentation to the user. For example, and without limitation, categories of user data determined by hyper-focus determiner 260, can comprise: information regarding interactions between the user and the GUI elements, such as past, current, or recent user inputs to the GUI element; information regarding GUI elements that have been open when the user is below a target productivity level for the day; relevant documents, such as documents that may be relevant to the user and the user's job; and/or other insights or information about the GUI element that may be relevant to the user or enterprise the user works for. Based on the user data, the hyper-focus determiner 260 may determine one or more hyper-focus elements. The remaining GUI elements may be classified as non-hyper-focus elements to be presented using the visually-deemphasized effect. An example illustratively depicting the hyper-focus element determined by hyper-focus determiner 260 (which may use hyper-focus data determination logic 235) and displayed using the hyper-focus effect is provided in FIGS. 3A through 3F.

In some implementations, hyper-focus determiner 260 may include one or more subcomponents operable to generate a hyper-focus element to present using the hyper-focus effect. In particular, a dedicated subcomponent may be used for determining a particular category of user data. Further, in some embodiments, the dedicated subcomponent may utilize hyper-focus data determination logic 235 that is specific for determining the particular category of user data (for example, whether the user data corresponds to user-activity data). As shown in example system 200, hyper-focus determiner 260 comprises GUI element determiner 262, active GUI element determiner 264, activity classifier 266, and GUI element hyper-focus attributer 268. GUI element determiner 262, in general, is responsible for determining GUI elements presented or displayed on the display surface of the computing device. Example GUI elements may include a computer application window, icon, button, or other visual aspect of a computer application or computer feature (for example, background or taskbar) presented on the display surface. In the context of a computer application, and without limitations, example GUI elements may include: files that may be editable by the user or otherwise receive user inputs; a document (for example, a presentation, a scripting interface, a spreadsheet); a calendar that comprises a schedule of events; a browser window; report; or other user-related files or documents such as described herein.

Some embodiments of GUI element determiner 262 can determine the GUI elements that have been launched or initiated by the computing device, which may be determined using hyper-focus data determination logic 235 and based on user data associated with the user, as described herein. Accordingly, embodiments of GUI element determiner 262 may process user data to determine GUI elements that may have manually been launched by the user since the beginning of the current user session, and may further process user data to determine which GUI elements have been subsequently closed or disabled. In particular, in some embodiments, the user data processed by GUI element determiner 262 comprises file-related activity (for example, file access, file creation, document comment activity, file-storage location data (such as a file repository associated with an enterprise, or other file-interaction information)), or communications data such as email, chats, and meeting-related communications. Further, in some embodiments, the user-activity data is processed by GUI element determiner 262 to determine interactions with a particular file, such as inputs to an interface. The user data, and the file-related or communications-related activity described previously, may be used for determining that a particular file has been launched and is a GUI element capable of being presented on the display background. The user data may be received, for example, from user activity monitor 250 (or a subcomponent, such as features determiner 256), user-data collection component 210, or from storage 225, such as from a user profile 240.

In some embodiments, the GUI element determiner 262 may determine the GUI elements that have been launched based on the user data (for example, user-activity data). For example, the user data can include, without limitation, a user input to launch a GUI element. User data may also include information associated with various types of communications, such as email, chats or chat sessions; meetings that may be online or in person; projects assigned to the user; calendar events or meetings that the user is scheduled to attend; or the like. Embodiments of GUI element determiner 262 may use user data associated with a user to determine a GUI element. The user data may be received, for example, from user activity monitor 250, user-data collection component 210, or from storage 225, such as from a user profile 240.

Active GUI element determiner 264, in general, is responsible for associating user activity with a particular GUI element. Based on the user activity associated with a particular GUI element, the active GUI element determiner may determine whether a GUI element is active. As used herein, an “active GUI element” refers to a GUI element that is launched either automatically (for example, at start-up) or manually by the user and continues to run on the computing device. In one embodiment, a GUI element ceases to be an active GUI element when the GUI element is closed or disabled, for example, by the user. In this manner, the active GUI element determiner 264 identifies the GUI elements (identified by the GUI element determiner 262) that remain active. Embodiments of active GUI element determiner 264 can process user data and user-activity data indicative of the user's interaction with a GUI element to determine whether the GUI element is active. In particular, in some embodiments, user data (such as input data [for instance, patterns of usage], file accesses or shares, or other user-activity data) is processed to determine whether a GUI element is active. For example, user data features may be compared to determine activity associated with the GUI element determined by the GUI element determiner 262, such as by performing a comparison of user data features that comprise information regarding the GUI element running based on a user input. Specifically, a comparison operation can be performed to determine previous user inputs, such as launching and not closing an application, which can indicate that the GUI element is active. The user data that is utilized by active GUI element determiner 264 may be received, for example, from user activity monitor 250 (or a subcomponent, such as features determiner 256), user-data collection component 210, or from storage 225, such as from a user profile 240.

According to another embodiment of a method performed by active GUI element determiner 264 for whether a GUI element is active, a log of activity within a particular GUI element may be logged and stored in storage 225. For instance, the log of activity within a particular GUI may be determined from user data associated with the particular user and stored in user data 244 of a user profile 240 for the particular user. Further, in some implementations, for user-activity data indicative of a user's inputs with respect to a particular GUI element is also determined and stored. For instance, the user-activity data may include a type of interaction with a GUI element (for example, a selection, looking at the GUI element (based on tracking the user's eyes), hovering over, a click, or other interaction), counts of interactions with each GUI element, the frequency of interaction, the rate of interaction (for example, over a time duration such as the number of times per month the user interacted with the GUI element), or similar user-activity data determined and stored in storage 225.

In some embodiments, relevance of an active GUI element may be determined by the active GUI element determiner 264 and be based on a productivity score. For example, as described previously, hyper-focus data determination logic 235 may be used to determine relevance of an active GUI element to a particular user, as well as for scoring or ranking an active GUI element for relevance or productivity. In particular, in some embodiments, where a plurality of active GUI elements are determined, a portion of the plurality of GUI elements may be determined to be in the user-attention state and provided to the user using the hyper-focus effect. For instance, in one embodiment, only the top two or three most relevant active GUI elements may be presented using the hyper-focus effect. The relevance to a user or level of productivity may be determined based on any number of criteria, such as, without limitation, user-activity data (for example, a selection, looking at the GUI element (based on tracking the user's eyes), hovering over, a click, or other interaction) associated with a computer application, counts of interactions with each GUI element, the frequency of interaction, the rate of interaction (for example, over a time duration such as the number of times per month the user interacted with the GUI element), or similar information, as described previously. Relevance or level of productivity also may be determined based on the freshness, or how recently the user interacted with an active GUI element, or it may be determined based on the importance of the active GUI element. For instance, a GUI element indicative of a message from a supervisor or manager may have a higher relevance or higher productivity than a GUI element indicative of a message from someone other than a supervisor or manager (such as from a social media computer application or dating computer application), which may be determined via an organizational chart, a list of permissible GUI elements (such as those not excluded by the exclusion determiner 270), and the like. Similarly, where the user context or intent indicates that the user may be preparing for an upcoming meeting or event, an active GUI element classified as useful for preparing for a meeting may be determined to be more relevant and associated with a higher productivity score than GUI element that is helpful in preparing for the upcoming meeting or event. In some implementations, hyper-focus data determination logic 235 may weight certain types of GUI elements for relevance or productivity more than others (such as by determining a productivity score based on the particular interaction), such that an active GUI element is more likely to be relevant and contribute to productivity than other GUI elements, and thus, more likely to be provided using the hyper-focus effect. For example, a GUI element that has received numerous user inputs (relevant to a work task) to a text field may be assigned a higher productivity score than a GUI element that includes a video stream of a television show during work hours.

Activity classifier 266, in general, is responsible for classifying a user activity that rendered the GUI element active (as determined by the active GUI element determiner 264) as a type of activity that would or would not be a good type of user activity to be associated with the user-attention state. For example, and without limitations, types of classifications or categories of the user activity include: productivity activity, such as activity indicating that a user is completing a work-related task (for example, drafting a document, watching a training video, composing an email, manipulating a document, looking at a screen (to read a work document) and so forth); non productivity activity, such as activity indicating that a user is performing acts not related a work-related task or an enterprise's goals (for example, streaming a video from a streaming website, playing online games, using personal email, reading a news article or electronic book, engaging in online shopping, and so forth); or a lack of activity, such as a user failing to engage with a computer (for example, by not looking at a screen and instead looking at a mobile phone, by not moving a mouse, by not tapping a touchscreen of the computing device, by not typing on the keyboard, by not increasing a sound volume, and the like) for a threshold period of time (such as one, two, ten, fifteen, thirty, or sixty minutes). Indeed, embodiments of activity classifier 266 can classify a user's interactions with a GUI element based on the type of activity, such as productivity activity, non-productivity activity, or a lack of activity. In some embodiments, the user activity may be received by the activity classifier 266 from the user activity monitor 250.

In some embodiments, classifying user-activity data may include generating a list of candidate user-activity data that may correspond to a GUI element that may be in the user-attention state. For example, the productivity activity may be associated with the user-attention state. To further help narrow the user activity to facilitate determining a more specific user activity associated with the hyper-focus element, in some embodiments, the user activity classified by GUI activity classifier 266 may be ranked based on a productivity score such that user activity associated with a GUI element and with performing a work-related task is more relevant and/or likely to be associated with the user-attention state. For example, hyper-focus data determination logic 235 may be used to determine a productivity score of classified user activity, as well as for scoring or ranking the classified user activity based on the productivity score. In one embodiment, the productivity score may be determined based on any number of criteria such as, without limitation, freshness (or how recently the classified user activity occurred); the type of classified user activity (such that productivity activity have a higher productivity score and/or may be ranked higher than non-productivity activity and a lack of activity); or the importance of a classified user activity to an enterprise. For instance, a group member that is a supervisor or manager may provide administrator preferences indicating that productivity activity is to be ranked higher than non-productivity activity and/or a lack of activity.

As described herein, some embodiments of hyper-focus determiner 260 may use hyper-focus data determination logic 235 to determine relevance of classified user activity, and further may determine a productivity score for a particular classified user activity. The productivity score of the classified user activity may be used to determine whether the corresponding GUI elements are to be tagged as hyper-focus elements by the GUI element hyper-focus attributer 268. (For example, as further described herein, some embodiments of hyper-focus presentation assembler 280 determine GUI elements to be presented using the visually-deemphasized effect or the hyper-focus effect based on their corresponding productivity score.) For instance, according to some embodiments, a set of classified user activity may be determined by hyper-focus determiner 260 (or its subcomponents) to be relevant. Then, for each classified user activity in the set (or for a subset of one or more of the classified user activity in the set), a productivity score may be determined and used for inferring relevance and/or a level of productivity of a classified user activity such that a high score (or, conversely, a low score) indicates higher (or lower) level of productivity or relevance. Embodiments of hyper-focus determiner 260 or hyper-focus data determination logic 235 may use user data associated with a particular user to determine the relevance (or likelihood of contributing to productivity) of classified user activity, which may be represented as the productivity score associated with the classified user activity.

In some embodiments, a productivity score of the classified user activity may be determined, for example and without limitation: based on the particular type or category of the classified user activity; based on user history, such as whether the user has previously been presented (or engaged) with a particular GUI element to accomplish a work-related task; and/or based on settings or preferences, such as user configurations/settings 246 in a user profile 240, which may be configured by the user or an administrator. As a non-limiting example, where the classified user activity is productivity activity associated with drafting a document in a word processing computer application, a productivity score may be determined based at least in part on properties of the user activity and/or metadata of the document. For instance, a modification or creation date of the document may be used to indicate how fresh or stale the document is. Similarly, the file name of the document may indicate its association with or relevance to the user, such as where the file name indicates that the file associated with a deliverable is of a high priority to the user. Furthermore, information about how often the document is accessed may be determined and used to indicate relevance and/or productivity. For instance, as described previously, a document that is frequently accessed may indicate that the document would be relevant and thus should be determined to be associated with a higher level of productivity, as reflected in its productivity score, so that it is more likely to be included among the GUI elements that are determined to be hyper-focus elements presented using the hyper-focus effect. As another example, where classified user activity comprises indications of user actions (within the document), such as clicks, key input (for example, indicative of typing), eye movement tracking, breaks while working on the document, such classified user activity may have higher relevance (and thus have a higher productivity score) than other types of classified user activity.

According to some embodiments, activity classifier 266 may further classify the user activity within classifications or categories. For example, after user activity has been classified into one of the three following categories discussed above: productivity activity, non-productivity activity, or a lack of activity, the activity classifier 266 may further classify the user activity. In one embodiment, the activity classifier 266 may classify user activity within a classification. For example, user activity that has been classified as productivity activity may further be classified as: communication activity (for example, activity related to communicating with co-workers or supervisors), deliverable activity (e.g., activity related to a task having a deadline), training activity, supervising activity, and so forth. In this manner, the activity classifier 266 may classify user activity into any number of classifications or categories organized in a hierarchical arrangement.

Some embodiments of activity classifier 266 include processing user data, such as user-activity data, using hyper-focus data determination logic 235. For instance, user activity may be classified based on user-activity data indicating that user activity corresponds to a particular classification or category of activity. The user-activity data indicating that the user activity corresponds to a particular classification or category may include data from the user profile 240 or the user activity monitor 250, including an indication of videos watched, files accessed, keystrokes logged, a screenshot of the display surface of the user's computing device, monitored kernels, network packets, and other suitable activity logs, such as the user-related activity discussed herein.

GUI element hyper-focus attributer 268, in general, is responsible for tagging or otherwise determining the GUI elements (determined by GUI element determiner 262) as hyper-focus elements in the user-attention state or non-hyper-focus elements to be presented using the visually-deemphasized effect, for example, using hyper-focus data determination logic 235. In one embodiment, the GUI element hyper-focus attributer 268 may receive an indication of the active GUI elements (determined by the GUI element determiner) so as to choose a subset of the active GUI elements to tag as hyper-focus GUI elements. In this manner, computation resources associated with tagging the GUI elements may be reduced since the non-active elements may be automatically tagged as non-hyper-focused elements to be presented using the visually-deemphasized effect, thereby reducing the computational space associated with determining which active GUI elements to tag as hyper-focus elements. Computational resources also may be further conserved based on the particular visually-deemphasized effect that is applied, such as a visually-deemphasized effect comprising grayscale, black-out, a monotone, or an altered brightness.

In some embodiments, the GUI element hyper-focus attributer 268 may tag the active GUI elements based on the user activity classified by activity classifier 266 and using hyper-focus data determination logic 235. For example, the GUI element hyper-focus attributer 268 may determine GUI elements that were rendered active by a particular classified user activity. GUI elements corresponding to user activity determined (by activity classifier 266) to be productivity activity may be candidate hyper-focused GUI elements. The GUI element hyper-focus attributer 268 may receive a ranking of the GUI elements corresponding to the ranked user activity (for example, based on the productivity score). The GUI element hyper-focus attributer 268 may tag a threshold number of GUI elements as hyper-focus GUI elements. For example, the GUI element hyper-focus attributer 268 may tag GUI elements corresponding to the top two ranked user activities as hyper-focus GUI elements.

By way of non-limiting example, suppose that four computer applications are running on a computer and stacked on a display surface. In particular, the user may have launched a word processing computer application, a media playing computer application, a web browser accessing a gambling website, and a calendar computer application. The GUI element determiner 262 may determine that only three computer applications are running, because the web browser accessing a gambling website was detected by the exclusion determiner 270 and is not identified by the GUI element determiner 262. The user may minimize the calendar computer application, such that the active GUI element determiner 264 determines that only the word processing computer application and a media playing computer application remain active. Thereafter, the activity classifier 266 may classify the user activity within the word processing computer application as productivity activity (because of the keywords observed and calendar information indicative that a deliverable is due at the end of the week). Similarly, the activity classifier 266 may classify the user activity within the media playing computer application as a non-productivity activity (because the content being played is a television show that does not relate to the deliverable due at the end of the week). Based on the activity classifier 266 classifying the word processing computer application as a productivity application, the GUI element hyper-focus attributer 268 may tag the word processing computer application as the hyper-focus element in the user-attention state to be presented using the hyper-focus effect. Accordingly, the entire display area, except the portion corresponding to the hyper-focus element (in this example, the word processing computer application) may be presented using the visually-deemphasized effect, as discussed below with respect to the hyper-focus presentation assembler 280.

Continuing with example system 200 and in reference to FIG. 2, hyper-focus presentation assembler 280 is generally responsible for assembling, formatting, or preparing hyper-focus elements in the user-attention state and non-hyper-focus elements for presentation to a user. In particular, embodiments of hyper-focus presentation assembler 280 may determine a set of hyper-focus GUI elements to provide to a user using the hyper-focus effect, a set of non-hyper-focus GUI elements to provide to the user using a visually-deemphasized effect, a quantity of hyper-focus elements provided, and/or the presentation or formatting of the GUI elements, for example, using the hyper-focus effect or the visually-deemphasized effect. In some embodiments, data indicative of the hyper-focus element and the non-hyper-focus element may be received from hyper-focus determiner 260 (or its subcomponents) or storage 225. In some embodiments, user data associated with a particular user and user-activity data associated with the particular user's actions with respect to a GUI element, which may be used to indicate that user's context and/or intent when interacting with a GUI element, may be used by hyper-focus presentation assembler 280 to determine and assemble the GUI elements via a GUI on the display surface using the hyper-focus effect or the visually-deemphasized effect. Thus, hyper-focus presentation assembler 280 also may receive user data and/or user-activity data, which may be received from user activity monitor 250 (or its subcomponents), user-data collection component 210, or a user profile 240. Further, in some embodiments of hyper-focus presentation assembler 280, the hyper-focus GUI element output by the hyper-focus determiner 260, and/or the presentation of the GUI elements using the hyper-focus effect or the visually-deemphasized effect is determined based on the user data associated with the user, such as described herein.

In some embodiments, hyper-focus GUI elements determined by hyper-focus determiner 260 have a corresponding productivity score (for example, a productivity score corresponding to the relevance and/or productivity that is determined for the corresponding user activity). Accordingly, embodiments of hyper-focus presentation assembler 280 can be configured to use the corresponding productivity score of user-activity data associated with a GUI element to rank, prioritize, or filter the GUI elements. For instance, GUI elements associated with a user activity that have a productivity score indicating greater relevance to the user (for example, a higher score) are more likely to be determined to be in the user-attention state, and therefore provided to the user using the hyper-focus effect. Further, as described in connection with hyper-focus determiner 260, the productivity score can be determined based on user data, which indicates a user context or intent. Therefore, in some embodiments, the GUI elements provided to a user using the hyper-focus effect or the visually-deemphasized effect are provided based on the user context or intent. In this way, presentation of GUI elements using either the hyper-focus effect or the visually-deemphasized effect may be considered to be contextualized for the user.

Some embodiments of hyper-focus presentation assembler 280 are configured to filter data output by the hyper-focus determiner 260, hereinafter referred to as “hyper-focus data.” Filtering hyper-focus data may facilitate providing a portion of the hyper-focus data that has greater relevance, as indicated by a determination of productivity (for example, a productivity score) of GUI elements, or a portion that includes other types of GUI elements, or both: a combination of other types of GUI elements and relevant GUI elements. For example, according to one embodiment, for a set of candidate GUI elements determined by hyper-focus determiner 260, hyper-focus presentation assembler 280 determines the type of GUI element (which may be determined, for instance, based on the particular subcomponent of hyper-focus determiner 260 that generated the GUI element). Then, in some embodiments, hyper-focus presentation assembler 280 can determine a number of the most relevant active GUI elements (for example, those having the highest productivity score) for presenting on the GUI using the hyper-focus effect, such as the top two or three most relevant GUI elements.

For example, in one embodiment, suppose the hyper-focus determiner 260 determines that a screen displays a task bar, a computer background, folders on the computer background, and a window corresponding to a word processing computer application that includes a tool bar and a document drafting portion. In this example, the candidate GUI elements determined by the hyper-focus determiner 260 include (1) the document drafting portion of the word processing computer application, (2) the tool bar of the word processing word application, and (3) the task bar. Accordingly, in this example, the hyper-focus determiner 260 did not determine the computer background and folders on the computer background to be candidate GUI elements. Thereafter, the hyper-focus presentation assembler 280 may determine that (1) the document drafting portion of the word processing computer application and (2) the tool bar of the word processing word application are types of GUI elements that can receive user inputs to accomplish a work-related task, such as finish drafting a document due soon. On the other hand, the hyper-focus presentation assembler 280 may determine that (3) the task bar is not a type of GUI element that can receive user inputs to accomplish a work-related task and may instead distract a user. Accordingly, in this example, the hyper-focus presentation assembler 280 presents (1) the document drafting portion of the word processing computer application and (2) the tool bar of the word processing word application using the hyper-focus effect. Although this example describes types of GUI elements as those that can receive user inputs to accomplish a particular work-related task, the type of GUI element may be based on the purpose of that a particular feature (for example: window, icon, scripting or drafting interface, tool bar, etc.) serves to the user and/or based on what type of user inputs the GUI element can receive (e.g., passive selections like in buttons or active inputs like in scripting interfaces).

In some embodiments, the types of GUI elements to be provided and/or the number of each type of GUI element provided are determined by hyper-focus presentation assembler 280 based on the context of the user. For instance, as described previously, the user data and/or user-activity data associated with the user, which indicates the user's context, can include information indicating a particular computer application being used by the user. Thus, the information about the particular computer application may be used by hyper-focus presentation assembler 280 to determine how much hyper-focus data to provide, and/or which type(s) of hyper-focus data to provide to the user. For example, if the computing device is a desktop or laptop, such as depicted in FIG. 3A, then hyper-focus presentation assembler 280 may determine to provide a greater number of GUI elements using the hyper-focus since there is more display size. In contrast, if the computing device is mobile device, then hyper-focus presentation assembler 280 may determine to provide fewer GUI elements, such as a small window of a larger mobile application presented on the display surface, for instance.

Similarly, in some instances, hyper-focus data (or a portion thereof) may be formatted by hyper-focus presentation assembler 280 for presentation to the user based on whether the GUI element is determined to be a hyper-focus element or a non-hyper-focus element. For example, the hyper-focus elements presented using the hyper-focus effect may be unaltered or visually enhanced relative to the negative visual effect (for example, the visually-deemphasized effect) applied to the non-hyper-focus elements. In one embodiment, the hyper-focus presentation assembler 280 may present the hyper-focus elements using the hyper-focus effect by not altering display of the hyper-focus elements. Alternatively, the hyper-focus presentation assembler 280 may present the hyper-focus elements using the hyper-focus effect by presenting the hyper-focus elements with a sharper image resolution, increased saturation level, and so forth. In one embodiment, the hyper-focus presentation assembler 280 may present the non-hyper-focus elements using the visually-deemphasized effect by applying a grayscale, black-out, a monotone, a blur, an altered saturation, an altered contrast, an altered hue, an altered brightness, or any other suitable visual alteration.

Some embodiments of hyper-focus presentation assembler 280 may assemble or format the hyper-focus data for consumption by a computer application or service. For example, as described previously, hyper-focus presentation assembler 280 may determine a set of GUI elements. Some embodiments of hyper-focus presentation assembler 280 use or generate presentation logic to specify the formatting of GUI elements, or to facilitate the formatting or presentation of the hyper-focus elements (using the hyper-focus effect) or of the non-hyper-focus elements (using the visually-deemphasized effect). For example, presentation logic may specify to initiate application of the visually-deemphasized effect to the entire display surface except to the hyper-focus element over a period of time (for example, three minutes) so as to minimally interrupt the user. Similarly, presentation logic may specify presentation format(s), as in the examples illustratively depicted in FIGS. 3A-3F.

Example system 200 also includes storage 225. Storage 225 generally stores information including data, computer instructions (for example, software program instructions, routines, or services), logic, profiles, and/or models used in embodiments described herein. In an embodiment, storage 225 comprises a data store (or computer data memory). Further, although depicted as a single data store component, storage 225 may be embodied as one or more data stores or may be in the cloud. As shown in example system 200, storage 225 includes user activity event logic 230 and hyper-focus data determination logic 235, as described previously. Storage 225 also includes an example embodiment of a user profile 240. Example user profile 240 includes information about user accounts and devices 242, user data 244 (such as user-activity data), and user configurations/settings 246. In some embodiments, the information stored in user profile 240 may be available to other components of example system 200.

User accounts and devices 242 generally includes information about user devices accessed, used, or otherwise associated with a user, and/or information related to user accounts associated with the user, which may be used for accessing or collecting user data for a user (such as a user interacting with a group or a group member). For example, information of user accounts and devices 242 may comprise: online or cloud-based accounts (for example, email, calendar, task tracking, social media) such as a Microsoft® MSA account or a Microsoft 365 account; other accounts such as entertainment or gaming-related accounts (for example, Xbox®, Netflix®, online game subscription accounts, or similar account information); user data that relates to such accounts, such as user emails, texts, instant messages, calls, other communications, and other content; social network accounts and data, such as news feeds; online activity; schedule, calendar, appointments, application data, other user accounts, or the like. Some embodiments of user accounts and devices 242 may store information across one or more databases, knowledge graphs, or data structures. As described previously, the information stored in user accounts and devices 242 may be determined from user-data collection component 210 or user activity monitor 250 (including one or more of its subcomponents).

As described previously, user data 244 generally includes information about a user, who may be associated with the user profile 240. User data 244 may include user data received from user-data collection component 210 or user data determined by user activity monitor 250 (or its subcomponents), which may include user-activity data, a context or contextual information, and user data features (or structured or semi-structured user data), in some embodiments. User data 244 also may include information regarding a user's activity with respect to a GUI element and/or may include information regarding GUI elements that are active on a display surface (for example, having been launched by a user). User data 244 also may include information regarding the user's interactions with one or more GUI elements, such as the number of interactions, frequency, or other data regarding the interactions that are relevant to the user, in some embodiments.

User configurations/settings 246 generally include user settings or preferences associated with embodiments described herein. By way of example and not limitation, such settings may include user configurations or preferences about the various thresholds described herein, confidence values associated with inferences (for example, an inference that a particular GUI element is in a user-attention state), explicitly defined settings regarding user data that may be used to determine hyper-focus data, exclusion data (used by the exclusions determiner 270 to determine the exclusions or inclusions discussed herein), administrator preferences or configurations regarding the exclusions or presentation of hyper-focus data to the user or consumption of hyper-focus data by computer applications and services used by the user, or other preferences or configuration settings for any of the embodiments described herein.

Example system 200 includes a presentation component 220 that is generally responsible for presenting content including aspects of the hyper-focus data, such as the hyper-focus elements (presented using the hyper-focus effect) and non-hyper-focus elements (presented using the visually-deemphasized effect) determined by hyper-focus determiner 260, and may work in conjunction with hyper-focus presentation assembler 280. The content may be presented via one or more presentation components 616, as described in FIG. 6. Presentation component 220 may comprise one or more applications or services on a user device or across multiple user devices or in the cloud. For example, in one embodiment, presentation component 220 manages the presentation of GUI elements to a user across multiple user devices associated with that user, or may use presentation logic determined by hyper-focus presentation assembler 280. For example, presentation component 220 may determine on which user device(s) content is presented and how or how much content is presented, and may present hyper-focus data determined by hyper-focus determiner 260 or other components of system 200. Presentation component 220 may present hyper-focus data, including any substitutions, reorganizations, or highlights as directed by presentation logic or by hyper-focus presentation assembler 280. In some embodiments, presentation component 220 can present hyper-focus data, such as GUI elements, proactively and dynamically, based on the user-action data. For example, presentation component 220 may determine when, whether, and how to present hyper-focus data based on a context and/or based on presentation logic from hyper-focus presentation assembler 280, which may reflect a context.

Some embodiments of presentation component 220 can determine how many GUI elements (such as hyper-focus GUI elements and/or non-hyper-focus GUI elements), if any, should be presented to a user. Alternatively, presentation logic may specify for presentation component 220, or hyper-focus presentation assembler 280 may instruct presentation component 220, how many GUI elements, if any, should be presented to a user. This determination can be made, for example, based upon the user device's screen size (with potentially more or differently formatted GUI elements presentable on, for instance, a laptop computer, as compared to a mobile phone) or the surface on which the GUI element will be presented (for example, a calendaring application, communication platform, or other application or program) such as described previously. The presentation component 220 can present, via a GUI, in a number of different formats and applications, such as those shown in FIGS. 3A through 3F (discussed further below). Presentation component 220 may also generate user interface features associated with or used to facilitate presenting GUI elements (such as shown in connection with FIGS. 3A through 3F). Such features can include interface elements (such as icons or indicators, graphics buttons, sliders, menus, audio prompts, alerts, alarms, vibrations, pop-up windows, notification-bar or status-bar items, in-app notifications, or other similar features for interfacing with a user), queries, and prompts.

With reference now to FIGS. 3A through 3F, a number of example schematic screenshots from a personal computing device are illustratively depicted, showing aspects of example graphical user interfaces that include presentation of various hyper-focus data, as described herein. The hyper-focus element(s) shown in FIGS. 3A through 3F may be determined and contextualized for a user, such as described in connection with the components of system 200 of FIG. 2. The example GUI elements represented in the hyper-focus data, as well as the formatting, assembly, or presentation may be determined as described in connection with hyper-focus presentation assembler 280 and presentation component 220 of FIG. 2.

Turning to FIG. 3A, an example schematic screen display 300 is shown, which may be presented via a computing device, such as user device 102n, discussed above with respect to FIG. 1. Screen display 300 is shown having a GUI 302, which may include GUI elements associated with any of a number of different computer programs, computer applications or other visual content on the computing device screen display 300. A smaller display surface 304 is shown, which may be, for example, a desktop background informational display. As illustrated, in one embodiment, the display surface 304 may have a width W1 and a height H1 as dimensions. Within display surface 304, a number of GUI elements are shown including GUI elements associated with a first computer application 310, GUI elements associated with a second computer application 312, and file/application icons 314. In one embodiment, a taskbar region 318 may be separate from the display surface 304, such that the taskbar region 318 remains on the GUI 302 as content in the display surface 304 changes (for example, in response to the visually-deemphasized effect being applied, or in response to computer applications being opened and manipulated). Alternatively, the taskbar region 318 may be part of the display surface 304, such that the taskbar region 318 also changes based on the visually-deemphasized effect being applied to portions of the display surface 304 excluding the hyper-focus element, such as depicted in FIG. 3C.

In this example of FIG. 3A, the GUI element of the first computer application 310 corresponds to a word processing document and the GUI element of the second computer application 312 corresponds to a browser. As illustrated, the GUI element of the first computer application 310 is determined to be in the user-attention state, while everything else on display surface 304 is presented using the visually-deemphasized effect. In this example, every portion of the display surface 304, except the GUI element of the first computer application 310, is presented in the visually-deemphasized effect. In particular, the second computer application 312 and the file/application icons 314 are presented using the visually-deemphasized effect. Although not depicted in FIG. 3A, in some embodiments, the taskbar region 318 also may be presented using the visually-deemphasized effect, such as shown in FIG. 3C.

The example visually-deemphasized effect depicted in FIG. 3A (and also depicted in FIGS. 3B-3F) includes presenting the non-hyper-focus elements using a crosshatch pattern so as to remove focus away from the content in the display surface 304 that does not correspond to the hyper-focus element determined to be in the user-attention state, which in this example is the GUI element associated with the first computer application 310. However, it should be understood that the visually-deemphasized effect may include any other visual alteration, such as, but not limited to, a grayscale, black-out, a monotone, a blur, an altered saturation, an altered contrast, an altered hue, an altered brightness, a color change, or any other suitable visual alteration, applied to the non-hyper-focus elements.

Furthermore, in this example, the hyper-focus element is determined to be the GUI element of the first computer application 310. In one embodiment, the hyper-focus determiner 260 may determine the hyper-focus element based on user data (for example, such as user-activity data) stored in user profile 240 of FIG. 2 or user data that is user-activity data determined by user activity monitor 250. The GUI element of the first computer application 310 may be determined to be the hyper-focus element based on the hyper-focus determiner 260 determining that user data and/or user-activity data indicates that particular user activity with respect to the first computer application corresponds to the first computer application (or one or more of its GUI elements) being in the user-attention state, and therefore should be presented using the hyper-focus effect. For example, the user data or user-activity may comprise user inputs (such as clicks, hovering inputs, right clicks, typed keys, the user's eyes focusing on aspects of the display surface 304) to first computer application, calendar or email indicating that a deadline (such as a deliverable that is due), a calendar or schedule of upcoming events (such as a meeting), and other user data, as described herein. For instance, the user data may indicate that the user has a deliverable, such as a typed document due at the end of the day and the user-activity data may indicate that the user is mostly interacting with (for example, typing or inputting content into) the first computer application. Based on the user data and user-activity data, the first computer application may be determined to be in the user-attention state. As a result, the GUI element of the first computer application 310 may be presented using the hyper-focus effect. As illustrated, a portion of the display surface 304 that does not include the GUI element of the first computer application 310 is presented using the visually-deemphasized effect.

In some embodiments, non-hyper-focus elements presented on the display surface 304 may remain displayed using the visually-deemphasized effect even when the user interacts with the non-hyper-focus element. For example, even in response to the non-hyper-focus elements being selected to be presented in front of other GUI elements, the non-hyper-focus element may continue to be presented using the visually-deemphasized effect while the hyper-focus element is presented using the hyper-focus effect. In some instances, this is the case even when the non-hyper-focus element is stacked on top of the hyper-focus element. Accordingly, with reference to the depicted example of FIG. 3A, in response to a selection or input into the GUI element of second computer application 312, the GUI element of the second computer application 312 may continue to be presented using the visually-deemphasized effect and/or the GUI element of the first computer application 310 presented using the hyper-focus effect.

Turning to FIG. 3B, another example screen display 330 is shown, which may be presented via a computing device, such as user device 102n, discussed above with respect to FIG. 1. Similar to the screen display 300 of FIG. 3A, example screen display 330 depicts a GUI 302 having a similar display surface 304 having dimensions width W2 and height H2. Within display surface 304, a number of GUI elements are shown including GUI elements associated with a first computer application 310, GUI elements associated with a second computer application 312, and file/application icons 314. Whereas in FIG. 3A, the hyper-focus element (for example, the GUI element determined to be in the user-attention state) presented using the hyper-focus effect is the GUI element of the first computer application 310, in FIG. 3B, the hyper-focus element presented using the hyper-focus effect is the GUI element of the second computer application 312. As a result, in the example of FIG. 3B, every portion of the display surface 304, except the second computer application 312, is presented using the visually-deemphasized effect. In particular, in this example, the GUI element of the first computer application 312 and the file/application icons 314 are presented using the visually-deemphasized effect.

The GUI element identified as a hyper-focus element may shift to another GUI element. In one embodiment, the GUI element identified as the hyper-focus element may shift based on a manual user input. For example, the hyper-focus element may shift from the GUI element of first computer application 310 (as shown in FIG. 3A) to the GUI element of the second computer application 312 in response to user-activity data indicating that the user has started to engage with the second computer application, for example, by selecting or providing an input with respect to the GUI element of the second computer application 312 (as shown in FIG. 3B).

In one embodiment, the GUI element identified as a hyper-focus element may automatically shift based on user data and/or user-activity data. For example, the hyper-focus element may automatically shift from the GUI element of the first computer application 310 (as shown in FIG. 3A) to the GUI element of the second computer application 312 (as shown in FIG. 3B) in response to user data indicating that the second computer application (or the GUI element of second computer application 312) corresponds to a GUI element which should receive user inputs to achieve a particular task. Continuing this example, the user data may indicate that the user has employee training scheduled in 1 minute. To facilitate notifying the user to begin focusing attention on the second computer application 312, the visually deemphasized effect may automatically shift from being applied to the GUI element of the second application 312 (as shown in FIG. 3A) to being applied to the GUI element of the first application 310 (as shown in FIG. 3B) based on the user data indicating the upcoming training session. Similarly, in another example, the visually deemphasized effect may automatically shift from being applied to the GUI element of the second application 312 (as shown in FIG. 3A) to being applied to the GUI element of the first application 310 (as shown in FIG. 3B) based on user-activity data indicating that the user hovers their selection (for example, mouse) over the GUI element of the second computer application 312.

In some embodiments, the transition between presenting a GUI element using the hyper-focus effect and the visually-deemphasized effect may occur over time (for example, 5, 10, 15, 20, 30, 50 seconds, or 1, 2, 5, 10, 20 minutes, or the like), so as to minimally disrupt the user. In one embodiment, presenting a GUI element using the visually-deemphasized effect may also occur over time (for example, 5, 10, 15, 20, 30, 50 seconds, or 1, 2, 5, 10, 20 minutes, or the like), so as to minimally disrupt the user. As discussed above, the hyper-focus presentation assembler 280 and/or the presentation component 220 may facilitate this transition in application of the visually-deemphasized effect. The time for transitioning may be based on the user data and/or the user-activity data.

Turning to FIG. 3C, another example screen display 350 is shown, which may be presented via a computing device, such as user device 102n, discussed above with respect to FIG. 1. Similar to the screen display 300 of FIG. 3A, example screen display 350 depicts a GUI 302 having a smaller display surface 304 having dimension width W3 and a height H3. Within display surface 304, a number of GUI elements are shown including GUI elements associated with a first computer application 310, GUI elements associated with a second computer application 312, and file/application icons 314, and/or a taskbar region 318. Similar to in FIG. 3B, the hyper-focus element presented using the hyper-focus effect is the GUI element of the second computer application 312. As a result, in this example, every portion of the display surface 304, except the GUI element of the second computer application 312, is presented in the visually-deemphasized effect. In particular, the GUI element of the first computer application 310, the file/application icons 314, and the taskbar region 318 are presented using the visually-deemphasized effect.

As illustrated, the GUI element of the second computer application 312 may be presented using the hyper-focus effect while the user provides input to or manipulates the computer application 312. In this example, the window corresponding to the GUI element of the second computer application 312 has been enlarged (relative to the size of the second computer application in FIG. 3B) and the user's employee ID (for the training session) has been inputted into a text field of the GUI element of the second computer application 312. During these user inputs, the second computer application 312 may remain presented using the hyper-focus effect, such that the portion of the display surface 304 that does not include the second computer application 312 is presented using the visually-deemphasized effect. In contrast to the examples of FIGS. 3A and 3B, in the example of FIG. 3C, the taskbar region 318 is presented using the visually-deemphasized effect.

Turning to FIG. 3D, another example screen display 360 is shown, which may be presented via a computing device, such as user device 102n, discussed above with respect to FIG. 1. Similar to the screen display 300 of FIG. 3A, example screen display 360 depicts a GUI 302 having a smaller display surface 304 having dimension width W4 and a height H4. Within display surface 304, a number of GUI elements are shown including a first GUI element 362 associated with a first computer application, a second GUI 363 element associated with the first computer application, a GUI element associated with a second computer application 365, file/application icons 314, and/or a taskbar region 318. In the example of FIG. 3D, the first computer application (or its GUI elements 362 and 363) are determined to be in a user-attention state. Thus the hyper-focus element presented using the hyper-focus effect are the first GUI element associated with a first computer application 362 and the second GUI element associated with the first computer application 363. Every portion of display surface 304, except the GUI elements 362 and 363 is presented in the visually-deemphasized effect in this example, including the GUI elements associated with a second computer application 365.

As illustrated in this example, more than one GUI element is presented using the hyper-focus effect. In particular, multiple GUI elements (GUI elements 362 and 363) associated with the first computer application are presented using the hyper-focus effect. Here, GUI element 362 corresponds to a word processing canvas for the first computer application, and GUI element 363 corresponds to a styles window for formatting fonts and styles of text on the canvas. In contrast to this example, in some embodiments, the hyper-focus effect may be applied only to one GUI element (or some but not all) of the GUI elements of a computer application. For example, if it is determined that the user is focused only on writing (instead of formatting style, editing, or the like), then GUI element 362, corresponding to the word processing canvas of the first computer application, may be displayed using the hyper-focus effect, and GUI element 363 (and in some instances other GUI elements of the first computer application, such as ribbon, menus, and/or other app features that are less relevant to writing) may be displayed using a visually-deemphasized effect.

Turning to FIG. 3E, another example screen display 370 is shown, which may be presented via a computing device, such as user device 102n, discussed above with respect to FIG. 1. Similar to the screen display 300 of FIG. 3A, example screen display 370 depicts a GUI 302 having a smaller display surface 304 having dimension width W5 and a height H5. Within display surface 304, a number of GUI elements are shown including a GUI element associated with a first computer application 372, a GUI element associated with a second computer application 374, and file/application icons 314, and/or a taskbar region 318. In the example of FIG. 3D, the GUI element associated with a first computer application 372 and the GUI elements associated with a second computer application 374 are both determined to be in a user-attention state. Thus both GUI elements 372 and 374 are determined to be hyper-focus elements and are presented using a hyper-focus effect. Every portion of display surface 304, except the GUI elements 372 and 374 is presented in the visually-deemphasized effect, in this example.

As illustrated in this example, GUI elements from more than one computer application are presented using a hyper-focus effect. Here, GUI element 372 corresponds to a word processing canvas for the first computer application, and GUI element 374 corresponds to a web browser application presenting content that is a financial analysis website. In this example, the user may be researching or reading content from the website (presented via GUI element 374) to be inputted into a document that is being drafted via the GUI element 372 (corresponding to the word processing canvas). Thus it may be determined (for example, by hyper-focus determiner 260 based on user data and/or user-activity data) that the both GUI elements 372 and 374 are in a user-attention state and thus should be presented using the hyper-focus effect.

Turning to FIG. 3F, another example screen display 380 is shown, which may be presented via a computing device, such as user device 102n, discussed above with respect to FIG. 1. Similar to the screen display 300 of FIG. 3A, example screen display 380 depicts a GUI 302 having a smaller display surface 304 having dimension width W6 and a height H6. Within display surface 304, a number of GUI elements are shown including a first GUI element 382 associated with a computer application, a second GUI element 384 associated with the same computer application, file/application icons 314, and/or a taskbar region 318. In the example of FIG. 3F, GUI element 382 of the computer application is determined to be in a user-attention state, and GUI element 384 of the same computer application is determined not to be user-attention state (or it is determined that GUI element 384 should not be in a user-attention state.) Thus, the hyper-focus element presented using the hyper-focus effect is GUI element 382. Every portion of display surface 304, except the GUI element 382, is presented in a visually-deemphasized effect, including the GUI element 384, which is associated with the same computer application as GUI element 382

As illustrated in this example, different GUI elements from the same computer application are presented differently. In particular, the example of FIG. 3F comprises an example of where the particular content presented via a computer application may be used to determine that a GUI element associated with the computer application should or should not be in a user-attention state, and thus should or should not be presented using the hyper-focus effect. Here, GUI elements 382 and 384 each correspond to an instance of the same browser computer application. GUI element 382 presents content that is a research publications website, and GUI element 384 presents content that is a social media website. In this example, it is determined (by hyper-focus determiner 260 or its subcomponents) that GUI element 382 has the user's focus (or should have the user's focus) and thus should be in a user-attention state, while GUI element 384 does not have the user's focus (or should not have the user's focus). For example, user data may indicate the user has an upcoming meeting regarding a particular topic that occurs on the research publications website. Thus the user's focus on GUI element 382 facilitates preparation for the meeting. In some embodiments, GUI element 382 may be determined to have a higher productivity score than GUI element 384, for example, based on the content presented via each of the GUIs.

Although in the example screenshots of FIGS. 3A through 3F include at least one GUI element presented using the hyper-focus effect, in some embodiments, the entire display surface 304 may instead be presented using the visually-deemphasized effect. For example, the hyper-focus determiner 260 of FIG. 2 may determine that none of the GUI elements are associated with user-activity data rising to a threshold level of productivity to be displayed as a hyper-focus element, such that the entire display surface 304 may instead be presented using the visually-deemphasized effect. In some instances of this example embodiment, the visually-deemphasized effect may remain on the entire display surface 304 until, for example, a GUI element is present that is associated with user-activity data rising to a threshold level of productivity. For instance, the user's display remains visually deemphasized until or unless the user opens up a productivity computer application; or for certain hours of the day, the user's display remains visually deemphasized until or unless the user opens up a productivity computer application; or in some instances, a productivity computer application may be automatically opened and presented using the hyper-focus effect. As another example, the hyper-focus determiner 260 of FIG. 2 may determine that the user is scheduled to take a break, such that the entire display surface 304 is transitioned to being displayed using the visually-deemphasized effect to notify the user that the break is coming up and/or encourage the user to step away from his computing device. In an embodiment, where none of the GUI elements are determined to be hyper-focus elements to be presented using the hyper-focus effect, the taskbar region 318 (or file/application icons 314) may automatically be presented using the hyper-focus effect to facilitate notifying the user that the relevant GUI element is on the taskbar or the start menu. In this manner, embodiments discussed herein allow for GUI elements to be presented in the hyper-focus effect, so as to facilitate navigating the user to a GUI element determined to be a hyper-focus element.

Turning now to FIGS. 4 and 5, aspects of an example process flows 400 and 500 are illustratively depicted for some embodiments of the disclosure. Process flows 400 and 500 each may comprise a method (sometimes referred to herein as method 400 and method 500) that may be carried out to implement various example embodiments described herein. For instance, process flow 400 or process flow 500 may be performed to programmatically determine a GUI element in the user-attention state based on user-activity data associated with the GUI element, which may be used to provide any of the improved technology or enhanced user computing experiences described herein.

Each block or step of process flow 400, process flow 500, and other methods described herein comprises a computing process that may be performed using any combination of hardware, firmware, and/or software. For instance, various functions may be carried out by a processor executing instructions stored in memory, such as memory 612 described in FIG. 6 and/or storage 225 described in FIG. 2. The methods may also be embodied as computer-usable instructions stored on computer storage media. The methods may be provided by a stand-alone application, a service or hosted service (stand-alone or in combination with another hosted service), or a plug-in to another product, to name a few. The blocks of process flow 400 and 500 that correspond to actions (or steps) to be performed (as opposed to information to be processed or acted on) may be carried out by one or more computer applications or services, in some embodiments, which may operate on one or more user devices (such as user device 102a), servers (such as server 106), and may be distributed across multiple user devices, and/or servers, or by a distributed computing platform, and/or may be implemented in the cloud, such as described in connection with FIG. 7. In some embodiments, the functions performed by the blocks or steps of process flows 400 and 500 are carried out by components of system 200, described in connection to FIG. 2.

With reference to FIG. 4, aspects of example process flow 400 are illustratively provided for determining a GUI element of a computer application, and, in some embodiments, monitoring user activity to determine user-activity data associated with the GUI element. In particular, example process flow 400 may be performed to classify the user-activity data as productivity data to determine whether the GUI element is in a user-attention state to be presented using the hyper-focus effect, as described in connection with FIG. 2. Presenting the GUI element using the hyper-focus effect may include causing a visually-deemphasized effect to be applied to a portion of the GUI that excludes the GUI element determined to be in the user-attention state, such as described in connection with FIG. 2.

At a block 410, method 400 includes determining a first GUI element of a first computer application being presented. In one embodiment, the GUI element determiner 262 of FIG. 2 may determine GUI elements presented or displayed on the display surface of the computing device, as discussed above. Additionally, the active GUI element determiner 264 of FIG. 2 may associate user activity with a particular GUI element to determine whether a particular GUI element is active. At block 420, method 400 includes monitoring user activity to determine user-activity data associated with the first GUI element. In one embodiment, the user-data collection component 210 of FIG. 2 may receive user data that may be communicated to the user activity monitor 250 of FIG. 2. At block 430, method 400 includes classifying the user-activity data as productivity activity. In one embodiment, activity classifier 266 may classify user activity that rendered the GUI element active (as determined by the active GUI element determiner 264) as a type of activity that would or would not be a good type of user activity to be associated with the user-attention state. At block 440, method 400 includes determining that the first GUI element is in a user-attention state. In one embodiment, the GUI element hyper-focus attributer 268 of FIG. 2 may tag the GUI elements (determined by GUI element determiner 262) as hyper-focus elements in the user-attention state or non-hyper-focus elements to be presented using the visually-deemphasized effect, for example, using hyper-focus data determination logic 235 of FIG. 2. At block 450, method 400 includes causing a visually-deemphasized effect to be applied to a portion of the GUI that excludes the first GUI element determined to be in the user-attention state. In one embodiment, the hyper-focus presentation assembler 280 and/or the presentation component 220 may configure hyper-focus data (e.g., data output by the hyper-focus determiner 260, the exclusion determiner 270, and/or the user activity monitor 250) for presentation, via a GUI, on a display screen.

With reference to FIG. 5, aspects of example process flow 500 are illustratively provided for determining GUI elements of a plurality of computer applications, and, in some embodiments, monitoring user activity associated with the GUI elements to determine user-activity data associated with each of the GUI elements. In particular, example process flow 400 may be performed to classify the user-activity data as productivity data to determine whether each of the GUI elements is in a user-attention state to be presented using the hyper-focus effect, as described in connection with FIG. 2. Presenting the GUI element using the hyper-focus effect may include applying a visually-deemphasize effect to a portion of the GUI that excludes the GUI elements determined to be in the user-attention state, such as described in connection with FIG. 2.

At a block 510, method 500 includes presenting, via a GUI, a first GUI element and a second GUI element on a display surface. The first GUI element may correspond to a visual aspect of a first computer application, and the second GUI element may correspond to a visual aspect of a second computer application. At block 520, method 500 includes monitoring user activity to determine first user-activity data associated with the first GUI element of the first computer application and second user-activity data associated with the second GUI element of the second computer application. At block 530, method 500 includes classifying the first user-activity data and the second user-activity data as productivity activity. At block 540, method 500 includes determining that the first GUI element and the second GUI element are in a user-attention state. At block 550, method 500 includes applying a visually-deemphasized effect to a portion of the GUI that excludes the first GUI element and the second GUI element both determined to be in the user-attention state.

Accordingly, we have described various aspects of technology directed to systems and methods for intelligently processing and classifying, via a computing device, user-activity data to apply a visually-deemphasized effect to a portion of the GUI that excludes GUI elements determined to be in a user-attention state. It is understood that various features, sub-combinations, and modifications of the embodiments described herein are of utility and may be employed in other embodiments without reference to other features or sub-combinations. Moreover, the order and sequences of steps shown in the example methods 400 and 500 are not meant to limit the scope of the present disclosure in any way, and, in fact, the steps may occur in a variety of different sequences within embodiments hereof. Such variations and combinations thereof are also contemplated to be within the scope of embodiments of this disclosure.

### OTHER EMBODIMENTS

In some embodiments, a computer system is provided, such as the computerized (or computer or computing) system described in any of the embodiments above. The computer system comprises at least one processor, and computer memory having computer-readable instructions embodied thereon, that, when executed by the at least one processor, perform operations. The operations comprise determining, by the processor, a first graphical user interface (GUI) element of a first computer application is being presented, via a GUI, on a display surface. The operations further comprise monitoring user activity to determine user-activity data associated with the first GUI element of the first computer application. The operations further comprise classifying the user-activity data as productivity activity. The operations further comprise, based at least on the classification, determining that the first GUI element of the first computer application is in a user-attention state. The operations further comprise causing a visually-deemphasized effect to be applied to a portion of the GUI that excludes at least the first GUI element of the first computer application determined to be in the user-attention state. Accordingly, embodiments of this disclosure address a need that arises from a very large scale of operations created by software-based services that cannot be managed by humans. The actions/operations described herein address results of a system that is a direct consequence of software used as a service offered in conjunction with users engaging with services hosted across a variety of platforms and devices. Further still, embodiments described herein enable certain GUI elements (for example, windows of a computer application) to be presented using a visually-deemphasized effect which may conserve computer processing resources and battery, provide an enhanced display of content on a GUI, and improve user productivity—all without requiring distracting user inputs or use of computing and network resources for a user to manually perform operations to produce this outcome. In this way, some embodiments, as described herein, reduce computational resources associated with otherwise presenting less relevant content (for example, GUI elements) with the same display properties (for example, resolution, saturation, and so forth) used to present relevant content (for example, GUI elements).

In any combination of the above embodiments of the system, causing the visually-deemphasizing effect to be applied comprises applying an operating system-level pixel adjuster to the portion of the display surface that excludes the first GUI element of the first computer application determined to be in the user-attention state.

In any combination of the above embodiments of the system, the visually-deemphasized effect comprises at least one of: grayscale, black-out, a monotone, a blur, an altered saturation, an altered contrast, an altered hue, or an altered brightness.

In any combination of the above embodiments of the system, determining that the first GUI element of the first computer application is in the user-attention state is further based on at least one of: a pattern of usage of the first computer application, administrator setting regarding the first computer application, user preferences, a calendar of the user, a scheduled meeting for the user, or content presented via the first computer application.

In any combination of the above embodiments of the system, the operations further comprise accessing a set of inclusions or exclusions, the inclusions comprising at least one indication of a computer application, website, or content that should be included in application of the visually-deemphasized effect, the exclusions comprising at least one indication of a computer application, website, or content that should be excluded from application of the visually deemphasized effect.

In any combination of the above embodiments of the system, the operations further comprise determining that a second GUI element of the first computer application or of a second computer application is in the user-attention state based on the set of inclusions or exclusions.

In any combination of the above embodiments of the system, the exclusion comprises a computer application, website, or content associated with an advertisement, and wherein the inclusion comprises a computer application, website, or content associated with social media, gambling, malware, phishing, or a restricted topic.

In any combination of the above embodiments of the system, the operations further comprise determining a schedule of a user based on the user-activity data, wherein causing to apply the visually-deemphasized effect is based on the schedule.

In any combination of the above embodiments of the system, the operations further comprise determining additional user-activity data associated with a second GUI element of a second computer application based on the monitored user activity; classifying the additional user-activity data as the productivity activity; based at least on the classification of the additional user-activity data, determining that the second GUI element is likely in the user-attention state; and causing the visually-deemphasized effect to be applied to the portion of the GUI that further excludes the second GUI element.

In any combination of the above embodiments of the system, the operations further comprise classifying the user-activity data as the productivity activity comprising determining a first productivity score for the user-activity data associated with the first GUI element of the first computer application. The operations further comprise determining additional user-activity data associated with a second GUI element of a second computer application based on the monitored user activity; classifying the additional user-activity data as the productivity activity including determining a second productivity score for the additional user-activity data associate with the second GUI element. Based on a comparison of the first and second productivity scores, if the first productivity score is higher than the second productivity score, the operations further comprise causing the visually-deemphasized effect to be applied to the second GUI element of the second computer application. Based on a comparison of the first and second productivity scores, if the second productivity score is higher than the first productivity score, the operations comprise causing the visually-deemphasized effect to transition to the first GUI element, such that the transition comprises applying the visually-deemphasized effect to another portion of the display surface that excludes the second GUI element and includes the first GUI element. Alternatively or additionally, based on a comparison of the first and second productivity scores, if the first productivity score and the second productivity score are the same or within a degree of similarity, the operations comprise causing the visually-deemphasized effect to be applied to the portion of the GUI that further excludes the second GUI element.

In some embodiments, a computerized method is provided. The method comprises presenting, via a graphical user interface (GUI), a first GUI element of a first computer application and a second GUI element of a second computer application on a display surface. The method further comprises monitoring user activity to determine first user-activity data associated with the first GUI element and second user-activity data associated with the second GUI element. The method further comprises classifying the first and second user-activity data as productivity activities. The method further comprises, based at least on the classification, determining that the first and second GUI element are associated with a user-attention state. The method further comprises applying a visually-deemphasized effect to a portion of the GUI that excludes the first and second GUI elements determined to be associated with the user-attention state, such that applying the visually-deemphasized effect comprises altering display of the portion of the GUI that excludes the first and second GUI elements while maintaining display of the first and second GUI elements. Accordingly, embodiments of this disclosure address a need that arises from a very large scale of operations created by software-based services that cannot be managed by humans. The actions/operations described herein address results of a system that is a direct consequence of software used as a service offered in conjunction with users engaging with services hosted across a variety of platforms and devices. Further still, embodiments described herein enable certain GUI elements (for example, windows of a computer application) to be presented using a visually-deemphasized effect which may conserve computer processing resources and battery, provide an enhanced display of content on a GUI, and improve user productivity—all without requiring distracting user inputs or use of computing and network resources for a user to manually perform operations to produce this outcome. In this way, some embodiments, as described herein, reduce computational resources associated with otherwise presenting less relevant content (for example, GUI elements) with the same display properties (for example, resolution, saturation, and so forth) used to present relevant content (for example, GUI elements).

In any combination of the above embodiments of the method, applying the visually-deemphasizing effect comprises applying an operating system-level pixel adjuster to the portion of the GUI that excludes the first and second GUI elements.

In any combination of the above embodiments of the method, classifying the first and second user-activity data as the productivity activity comprising determining a first and second productivity score for the first and second user-activity data associated with the first and second GUI element, respectively. The method further comprises comparing the first and second productivity score. Based on a comparison of the first and second productivity scores, the method comprises if the first productivity score is higher than the second productivity score, causing the visually-deemphasized effect to be applied to the second GUI element of the second computer application. Based on a comparison of the first and second productivity scores, the method comprises if the second productivity score is higher than the first productivity score, causing the visually-deemphasized effect to transition to the first GUI element, wherein the transition comprises applying the visually-deemphasized effect to another portion of the display surface that excludes the second GUI element and includes the first GUI element. Based on a comparison of the first and second productivity scores, the method comprises if the first productivity score and the second productivity score are the same or within a degree of similarity, causing the visually-deemphasized effect to be applied to the portion of the GUI that further excludes the second GUI element.

In any combination of the above embodiments of the method, the visually-deemphasized effect is applied over time, wherein the timing of applying the visually-deemphasized effect is based on the user-activity data.

In any combination of the above embodiments of the method, the first user-activity data comprises at least one of the following for each of the first computer application and the second computer application: a pattern of application usage, administrator preferences regarding permissible access, user preferences, or content presented on the first computer application.

In some embodiments, computer storage media is provided, such as any of the computer storage media described herein, that, when executed by at least one computer processor, causes computing operations to be performed. The operations further comprise determining, by the processor, a first graphical user interface (GUI) element of a first computer application is being presented, via a GUI, on a display surface. The operations further comprise monitoring user activity to determine user-activity data associated with the first GUI element of the first computer application, and classifying the user-activity data as productivity activity. The operations further comprise, based at least on the classification, determining that the first GUI element of the first computer application is in a user-attention state. The operations further comprise causing a visually-deemphasized effect to be applied to a portion of the GUI that excludes at least the first GUI element of the first computer application determined to be in the user-attention state. Accordingly, embodiments of this disclosure address a need that arises from a very large scale of operations created by software-based services that cannot be managed by humans. The actions/operations described herein address results of a system that is a direct consequence of software used as a service offered in conjunction with users engaging with services hosted across a variety of platforms and devices. Further still, embodiments described herein enable certain GUI elements (for example, windows of a computer application) to be presented using a visually-deemphasized effect which may conserve computer processing resources and battery, provide an enhanced display of content on a GUI, and improve user productivity—all without requiring distracting user inputs or use of computing and network resources for a user to manually perform operations to produce this outcome. In this way, some embodiments, as described herein, reduce computational resources associated with otherwise presenting less relevant content (for example, GUI elements) with the same display properties (for example, resolution, saturation, and so forth) used to present relevant content (for example, GUI elements).

In any combination of the above embodiments of the computer storage media, causing the visually-deemphasizing effect to be applied comprises applying an operating system-level pixel adjuster to the portion of the display surface that excludes the first GUI element of the first computer application determined to be in the user-attention state.

In any combination of the above embodiments of the computer storage media, the operations further comprise determining a schedule of a user based on the user-activity data, wherein causing to apply the visually-deemphasized effect is based on the schedule.

In any combination of the above embodiments of the computer storage media, the operations further comprise determining additional user-activity data associated with a second GUI element of a second computer application based on the monitored user activity and classifying the additional user-activity data as the productivity activity. The operations further comprise, based at least on the classification of the additional user-activity data, determining that the second GUI element is likely in the user-attention state. The operations further comprise causing the visually-deemphasized effect to be applied to the portion of the GUI that further excludes the second GUI element.

In any combination of the above embodiments of the computer storage media, classifying the first and second user-activity data as the productivity activity comprising determining a first and second productivity score for the first and second user-activity data associated with the first and second GUI element, respectively. The method further comprises comparing the first and second productivity score. Based on a comparison of the first and second productivity scores, the method comprises if the first productivity score is higher than the second productivity score, causing the visually-deemphasized effect to be applied to the second GUI element of the second computer application. Based on a comparison of the first and second productivity scores, the method comprises if the second productivity score is higher than the first productivity score, causing the visually-deemphasized effect to transition to the first GUI element, wherein the transition comprises applying the visually-deemphasized effect to another portion of the display surface that excludes the second GUI element and includes the first GUI element. Based on a comparison of the first and second productivity scores, the method comprises if the first productivity score and the second productivity score are the same or within a degree of similarity, causing the visually-deemphasized effect to be applied to the portion of the GUI that further excludes the second GUI element.

### Example Computing Environments

Having described various implementations, several example computing environments suitable for implementing embodiments of the disclosure are now described, including an example computing device and an example distributed computing environment in FIGS. 6 and 7, respectively. With reference to FIG. 6, an example computing device is provided and referred to generally as computing device 600. The computing device 600 is but one example of a suitable computing environment and is not intended to suggest any limitation as to the scope of use or functionality of embodiments of the disclosure. Neither should the computing device 600 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating to, for example, logic, control, and memory operations. Low level software written in machine code can provide more complex functionality to higher levels of software. Accordingly, in some embodiments, computer-executable instructions may include any software, including low level software written in machine code, higher level software such as application software, and any combination thereof. In this regard, the system components can manage resources and provide services for system functionality. Any other variations and combinations thereof are contemplated with the embodiments of the present disclosure.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more buses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Example hardware devices include, without limitation, solid-state memory, hard drives, and optical-disc drives. Computing device 600 includes one or more processors 614 that read data from various entities such as memory 612 or I/O components 620. Presentation component(s) 616 presents data indications to a user or other device. Example presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, or a wireless device. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (for example, a primary connection and a secondary connection). A short-range connection may include, by way of example and not limitation, a Wi-Fi® connection to a device (for example, mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Referring now to FIG. 7, an example distributed computing environment 700 is illustratively provided, in which implementations of the present disclosure may be employed. In particular, FIG. 7 shows a high level architecture of an example cloud computing platform 710 that can host a technical solution environment, or a portion thereof (for example, a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 700 that include cloud computing platform 710, rack 720, and node 730 (for example, computing devices, processing units, or blades). The technical solution environment can be implemented with cloud computing platform 710, which runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (for example, operating system or runtime environment) running a defined software stack on node 730. Node 730 can also be configured to perform specialized functionality (for example, compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms “service application,” “application,” or “service” are used interchangeably with regards to FIG. 7, and broadly refer to any software, or portions of software, that run on top of, or access storage and computing device locations within, a datacenter.

When more than one separate service application is being supported by nodes 730, nodes 730 may be partitioned into virtual machines (for example, virtual machine 752 and virtual machine 754). Physical machines can also concurrently run separate service applications. The virtual machines or physical machines can be configured as individualized computing environments that are supported by resources 760 (for example, hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device, referred to as a cluster. Each server in the cluster can be implemented as a node.

Client device 780 may be linked to a service application in cloud computing platform 710. Client device 780 may be any type of computing device, such as user device 102n described with reference to FIG. 1, and the client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a computing device or a distributed computing environment; however, the computing device and distributed computing environment depicted herein is merely examples. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer system, comprising:
a processor; and
computer memory storing computer-readable instructions thereon which, when executed by the processor, perform operations comprising:
determining, by the processor, a first graphical user interface (GUI) element of a first computer application is being presented, via a GUI, on a display surface;
monitoring user activity to determine user-activity data associated with the first GUI element of the first computer application;
classifying the user-activity data as productivity activity associated with the first computer application;
determining, from the user-activity data classified as productivity activity, a current productivity score that is indicative of a current contextual level of productivity associated with the first computer application;
based at least on the classification and the current productivity score, determining that the first GUI element of the first computer application is in a user-attention state; and
causing a visually-deemphasized effect to be applied to a portion of the GUI that excludes at least the first GUI element of the first computer application determined to be in the user-attention state.

2. The system of claim 1, wherein causing the visually-deemphasizing effect to be applied comprises applying an operating system-level pixel adjuster to a portion of the display surface that excludes the first GUI element of the first computer application determined to be in the user-attention state.

3. The system of claim 1, wherein the visually-deemphasized effect comprises at least one of: grayscale, black-out, a monotone, a blur, an altered saturation, an altered contrast, an altered hue, or an altered brightness.

4. The system of claim 1, wherein determining that the first GUI element of the first computer application is in the user-attention state is further based on at least one of: a pattern of usage of the first computer application, administrator setting regarding the first computer application, user preferences, a calendar of the user, a scheduled meeting for the user, or content presented via the first computer application.

5. The system of claim 1, wherein the operations further comprise:
accessing a set of inclusions or exclusions, the inclusions comprising at least one indication of a computer application, website, or content that should be included in application of the visually-deemphasized effect, the exclusions comprising at least one indication of a computer application, website, or content that should be excluded from application of the visually deemphasized effect.

6. The system of claim 5, wherein the operations further comprise:
determining that a second GUI element of the first computer application or of a second computer application is in the user-attention state based on the set of inclusions or exclusions, wherein the exclusion comprises a computer application, website, or content associated with an advertisement, and wherein the inclusion comprises a computer application, website, or content associated with social media, gambling, malware, phishing, or a restricted topic.

7. (canceled)

8. The system of claim 1, wherein the operations further comprise determining a schedule of a user based on the user-activity data, wherein causing to apply the visually-deemphasized effect is based on the schedule.

9. The system of claim 1, wherein the operations further comprise:
determining additional user-activity data associated with a second GUI element of a second computer application based on the monitored user activity;
classifying the additional user-activity data as the productivity activity;
based at least on the classification of the additional user-activity data, determining that the second GUI element is likely in the user-attention state; and
causing the visually-deemphasized effect to be applied to the portion of the GUI that further excludes the second GUI element.

10. The system of claim 1, wherein classifying the user-activity data as the productivity activity comprising determining a first productivity score for the user-activity data associated with the first GUI element of the first computer application; and wherein the operations further comprise:
determining additional user-activity data associated with a second GUI element of a second computer application based on the monitored user activity;
classifying the additional user-activity data as the productivity activity including determining a second productivity score for the additional user-activity data associate with the second GUI element; and
based on a comparison of the first and second productivity scores:
if the first productivity score is higher than the second productivity score, causing the visually-deemphasized effect to be applied to the second GUI element of the second computer application;
if the second productivity score is higher than the first productivity score, causing the visually-deemphasized effect to transition to the first GUI element, wherein the transition comprises applying the visually-deemphasized effect to another portion of the display surface that excludes the second GUI element and includes the first GUI element; or
if the first productivity score and the second productivity score are the same or within a degree of similarity, causing the visually-deemphasized effect to be applied to the portion of the GUI that further excludes the second GUI element.

11. A computer-implemented method, comprising:
presenting, via a graphical user interface (GUI), a first GUI element of a first computer application and a second GUI element of a second computer application on a display surface;
monitoring user activity to determine first user-activity data associated with the first GUI element and second user-activity data associated with the second GUI element;
classifying the first and second user-activity data as productivity activities associated with the first computer application and the second computer application;
determining, from the user-activity data classified as productivity activity, a current productivity score that is indicative of a current contextual level of productivity associated with the first computer application and the second computer application;
based at least on the classification and the current productivity score, determining that the first and second GUI element are associated with a user-attention state; and
applying a visually-deemphasized effect to a portion of the GUI that excludes the first and second GUI elements determined to be associated with the user-attention state, wherein applying the visually-deemphasized effect comprises altering display of the portion of the GUI that excludes the first and second GUI elements while maintaining display of the first and second GUI elements.

12. The computer-implemented method of claim 11, wherein applying the visually-deemphasizing effect comprises applying an operating system-level pixel adjuster to the portion of the GUI that excludes the first and second GUI elements.

13. The computer-implemented method of claim 11, wherein classifying the first and second user-activity data as the productivity activity comprising determining a first and second productivity score for the first and second user-activity data associated with the first and second GUI element, respectively; and the computer-implemented method further comprising:
comparing the first and second productivity score; and
based on a comparison of the first and second productivity scores:
if the first productivity score is higher than the second productivity score, causing the visually-deemphasized effect to be applied to the second GUI element of the second computer application;
if the second productivity score is higher than the first productivity score, causing the visually-deemphasized effect to transition to the first GUI element, wherein the transition comprises applying the visually-deemphasized effect to another portion of the display surface that excludes the second GUI element and includes the first GUI element; or
if the first productivity score and the second productivity score are the same or within a degree of similarity, causing the visually-deemphasized effect to be applied to the portion of the GUI that further excludes the second GUI element.

14. The computer-implemented method of claim 11, wherein the visually-deemphasized effect is applied over time, wherein the timing of applying the visually-deemphasized effect is based on the user-activity data.

15. The computer-implemented method of claim 11, wherein the first user-activity data comprises at least one of the following for each of the first computer application and the second computer application: a pattern of application usage, administrator preferences regarding permissible access, user preferences, or content presented on the first computer application.

16. A computer-readable storage medium storing computer-readable instructions thereon which, when executed by a processor, cause the processor to:
determine, by the processor, a first graphical user interface (GUI) element of a first computer application is being presented, via a GUI, on a display surface;
monitor user activity to determine user-activity data associated with the first GUI element of the first computer application;
classify the user-activity data as productivity activity associated with the first computer application;
determine, from the user-activity data classified as productivity activity, a current productivity score that is indicative of a current contextual level of productivity associated with the first computer application;
based at least on the classification and the current productivity score, determine that the first GUI element of the first computer application is in a user-attention state; and
cause a visually-deemphasized effect to be applied to a portion of the GUI that excludes at least the first GUI element of the first computer application determined to be in the user-attention state.

17. The computer-readable storage medium of claim 16, wherein causing the visually-deemphasizing effect to be applied comprises applying an operating system-level pixel adjuster to the portion of the GUI that excludes the first GUI element of the first computer application determined to be in the user-attention state.

18. The computer-readable storage medium of claim 16, wherein the instructions further cause the processor to determine a schedule of a user based on the user-activity data, wherein causing to apply the visually-deemphasized effect is based on the schedule.

19. The computer-readable storage medium of claim 16, wherein the instructions further cause the processor to:
determine additional user-activity data associated with a second GUI element of a second computer application based on the monitored user activity;
classify the additional user-activity data as the productivity activity;
based at least on the classification of the additional user-activity data, determine that the second GUI element is likely in the user-attention state; and
cause the visually-deemphasized effect to be applied to the portion of the GUI that further excludes the second GUI element.

20. The computer-readable storage medium of claim 16, wherein classifying the user-activity data as the productivity activity comprising determining a first productivity score for the user-activity data associated with the first GUI element of the first computer application; and wherein the instructions further cause the processor to:
determine additional user-activity data associated with a second GUI element of a second computer application based on the monitored user activity;
classify the additional user-activity data as the productivity activity including determining a second productivity score for the additional user-activity data associated with the second GUI element; and
based on a comparison of the first and second productivity scores:
if the first productivity score is higher than the second productivity score, cause the visually-deemphasized effect to be applied to the second GUI element of the second computer application;
if the second productivity score is higher than the first productivity score, cause the visually-deemphasized effect to transition to the first GUI element, wherein the transition comprises applying the visually-deemphasized effect to another portion of the display surface that excludes the second GUI element and includes the first GUI element; or
if the first productivity score and the second productivity score are the same or within a degree of similarity, cause the visually-deemphasized effect to be applied to the portion of the GUI that further excludes the second GUI element.

21. The system of claim 1, wherein the visually-deemphasizing effect is applied by an operating system layer associated with the computer system.
